(19) United States
(12) Patent Application Publication
(10) Pub. No.: US 2026/0300804 A1
(43) Pub. Date: Oct. 1, 2026

(54) SYSTEM AND METHODS FOR PSEUDO-LABELING POINT CLOUDS

(71) Applicant: Torc Robotics, Inc., Blacksburg, VA (US)

(72) Inventors: Filippo Ghilotti, Stuttgart (DE); Nahku Saidy, Stuttgart (DE); Samuel Brucker, Hardthausen (DE); Mario Bijelic, Frankfurt (DE); Felix Heide, New York, NY (US); Edoardo Palladin, Stuttgart (DE); Matteo Matteucci, Saronno (IT)

(21) Appl. No.: 19/053,146

(22) Filed: Feb. 13, 2025

Related U.S. Application Data
(60) Provisional application No. 63/730,325, filed on Dec. 10, 2024.

(51) Int. Cl. G06N 20/00; B60W 60/00; G01C 21/00

(52) U.S. Cl. CPC G06N 20/00; G01C 21/3833; B60W 60/00; B60W 2556/40

(57) ABSTRACT

A system and method for pseudo-labeling point cloud data for training machine learning models is provided. The system is configured to receive first sensor data of an environment in which an autonomous vehicle could travel; receive second sensor data of the environment; generate second semantic maps of the second modality based on the second sensor data; generate first semantic maps of the first modality based on the second semantic maps; generate a world map of the first sensor data by: removing moving objects from the first sensor data to derive static first sensor data; and accumulating the static first sensor data into the world map. The system is further configured to generate a labeled map of the first sensor data by combining the first semantic maps with the world map, the labeled map including the semantic labels; and output the labeled map.

### CROSS-REFERENCE TO RELATED APPLICATIONS

This application claims priority to U.S. Provisional Patent Application No. 63/730,325, filed Dec. 10, 2024, titled SYSTEM AND METHODS FOR LIDAR PSEUDO-LABELING, the contents of which are hereby incorporated herein by reference.

### TECHNICAL FIELD

The field of the disclosure relates generally to autonomous vehicles and, more specifically, to a system and method for labeling data for developing autonomous vehicles.

### BACKGROUND OF THE INVENTION

An autonomous vehicle relies on an autonomy computing system to perceive the environment in which the autonomous vehicle operates, control operation of the autonomous vehicle, and/or perform the operation of the autonomous vehicle. The autonomy computing system includes one or more machine learning models. To develop the machine learning models, large datasets are needed to train and test the performance of the machine learning models. The machine learning models typically include at least one supervised or semi-supervised machine learning model, where at least part of the development datasets needs to be annotated or labeled to provide ground truth for the learning. Labeling datasets, especially those datasets containing three-dimensional (3D) point clouds, such as point clouds acquired by Light Detection and Ranging (LiDAR) sensors, is labor intensive, time consuming, and demanding on the computer resources, such as memory and computation power. Accordingly, it is desirable to have improved systems and methods of producing pseudo labels for point cloud datasets.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### BRIEF SUMMARY OF THE INVENTION

In one aspect, an autonomy computing system of an autonomous vehicle for pseudo labeling of points cloud is provided. The autonomy computing system includes at least one processor in communication with at least one memory device. The at least one processor is programmed to receive sensor data of an environment in which the autonomous vehicle is operating. The at least one processor is programmed to receive first sensor data of an environment in which an autonomous vehicle could travel, the first sensor data acquired by at least one first sensor of a first modality and being in 3D point clouds and receive second sensor data of the environment, the second sensor data acquired by at least one second sensor of a second modality and including semantic information. The at least one processor is further programmed to generate second semantic maps of the second modality based on the second sensor data, the second semantic maps including semantic labels of objects in the environment. The at least one processor is further programmed to generate first semantic maps of the first modality based on the second semantic maps. The at least one processor is further programmed to generate a world map of the first sensor data by: removing moving objects from the first sensor data to derive static first sensor data and accumulating the static first sensor data into the world map. The at least one processor is further programmed to generate a labeled map of the first sensor data by combining the first semantic maps with the world map, the labeled map including the semantic labels, and output the labeled map.

In another aspect, a method for pseudo labeling of points cloud is provided. The at least one processor is programmed to receive sensor data of an environment in which the autonomous vehicle is operating. The method includes receiving first sensor data of an environment in which an autonomous vehicle could travel, the first sensor data acquired by at least one first sensor of a first modality and being in 3D point clouds and receiving second sensor data of the environment, the second sensor data acquired by at least one second sensor of a second modality and including semantic information. The method further includes generating second semantic maps of the second modality based on the second sensor data, the second semantic maps including semantic labels of objects in the environment. The method further includes generating first semantic maps of the first modality based on the second semantic maps. The method further includes generating a world map of the first sensor data by: removing moving objects from the first sensor data to derive static first sensor data and accumulating the static first sensor data into the world map. The method further includes generating a labeled map of the first sensor data by combining the first semantic maps with the world map, the labeled map including the semantic labels and outputting the labeled map.

In another aspect, at least one non-transitory computer-readable storage medium for pseudo-labeling three-dimensional (3D) point clouds for developing an autonomous vehicle comprising a plurality of instructions stored thereon that, in response to being executed, cause the at least one processor to: receive first sensor data of an environment in which an autonomous vehicle could travel, the first sensor data acquired by at least one first sensor of a first modality and being in 3D point clouds and receive second sensor data of the environment the second sensor data acquired by at least one second sensor of a second modality and including semantic information. The instructions further cause the at least one processor to generate second semantic maps of the second modality based on the second sensor data, the second semantic maps including semantic labels of objects in the environment. The instructions further cause the at least one processor to generate first semantic maps of the first modality based on the second semantic maps. The instructions further cause the at least one processor to generate a world map of the first sensor data by: removing moving objects from the first sensor data to derive static first sensor data and accumulating the static first sensor data into the world map. The instructions further cause the at least one processor to generate a labeled map of the first sensor data by combining the first semantic maps with the world map, the labeled map including the semantic labels and output the labeled map.

### BRIEF DESCRIPTION OF DRAWINGS

The patent or application file contains at least one drawing executed in color. Copies of this patent or patent application publication with color drawing(s) will be provided by the Office upon request and payment of the necessary fee.

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic diagram of an autonomous vehicle;

FIG. 2 is a block diagram of an autonomous vehicle;

FIG. 3 is a flowchart showing an example method associated with a pseudo-label generation computing device;

FIG. 4 is a flowchart showing an example method of generating pseudo-labels;

FIG. 5 is a block diagram of an example computing device;

FIG. 6 is a block diagram of an example user computing device;

FIG. 7 is a block diagram of an example server computing device;

FIG. 8 an example algorithm for probabilistic label refinement and propagation;

FIGS. 9A-9C show example dynamic scene decomposition outputs;

FIG. 10 shows example high-quality depth maps from short range Light Detection and Ranging sensors (LiDARs);

FIGS. 11A-11D show the effect of pseudo labels on Point-to-Voxel Knowledge Distillation (PVKD);

FIG. 12 with partial views FIGS. 12A and 12B show a table of an evaluation of semantic segmentation for class Intersection over Union (IoU), where the approximate relationship between the partial views of FIGS. 12A and 12B is provided by FIG. 12;

FIG. 13 shows a table of evaluations of semantic segmentation for class IoU;

FIGS. 14A-14C show an example of the qualitative effect of training with object pseudo-labels;

FIG. 15 shows a table displaying object detection evaluation results for 3D object detection;

FIG. 16 shows example images from a long-range highway dataset in different environments, light and weather conditions;

FIG. 17 shows a table of dynamic object evaluation with Frequency-Modulated Continuous-Wave (FMCW) technology, with and without applying a spatial proximity filter for measurement consistency, removing cluttered single points from the ground truth;

FIGS. 18A and 18B show a visualization of different channels settings for mapping module fmap;

FIGS. 19A-19D show the effects of spline optimization on yaw and position of bounding boxes, comparing the raw to the optimized yaw;

FIGS. 20A-20B show a fully-labeled Karlsruhe Institute of Technology and Toyota Technological Institute (KITTI) dataset map after applying the labeling module described herein;

FIG. 21 shows per-scene pseudo label evaluations against the ground truth labels from SemanticKITTI training sequences.

FIG. 22 shows per-class pseudo label evaluations against the ground truth labels from SemanticKITTI training sequences;

FIGS. 23A and 23B show an example retrieval of 360 degrees of labeling from a camera-only view being re-compared with a LiDAR scan;

FIG. 24A-24D shows additional qualitative results for semantic segmentation, results of predictions of the models trained respectively on 10% ground truth labels (10-0), on 100% ground truth labels (Oracle), and on 10% ground truth labels coupled with 90% of pseudo labels;

FIGS. 25A and 25B shows an example output following removal of floating points from a scene (FIG. 25B, on the right), comparing the output of labeling module to a normal SLAM (Simultaneous Localization and Mapping) method (FIG. 25A, on the left);

FIG. 26 shows example high quality long range accumulated depth maps;

FIG. 27 shows more example high quality long range accumulated depth maps;

FIG. 28 shows more example high quality long range accumulated depth maps;

FIG. 29 shows example pseudo bounding boxes; and

FIG. 30 shows more example pseudo bounding boxes.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing. The drawings are not to scale unless otherwise noted.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

The disclosed systems and methods are described, for clarity, using certain terminology when referring to and describing relevant components within the disclosure. Where possible, common industry terminology is employed in a manner consistent with its accepted meaning. Unless otherwise stated, such terminology should be given a broad interpretation consistent with the context of the present application and the scope of the appended claims.

Systems and methods for pseudo-labeling point clouds are provided. Light detection and ranging (LiDAR) point cloud data and camera data are described herein as examples for illustration purposes only. Systems and methods described herein may be applied to label any types of point cloud data, such as radio detection and ranging (radar) point cloud data, and sensor data of any modality having semantic information may be used in the labeling processes. An autonomy computing system of an autonomous vehicle is used to detect features in the environment in which the autonomous vehicle operates, generate control policies based on the features, and execute the control policies to control operation of the autonomous vehicle. The autonomy computing system includes one or more machine learning models. In developing the machine learning models, a relatively large amount of training data is needed to reduce overfitting and/or underfitting of the models, and at least one machine learning model requires supervised or semi-supervised training, where ground truth or annotated or labeled data are needed in the training data. Besides the relatively large amount of data, manually labeling point cloud data is presented with additional challenges due to the high dimensionality and intricacies involved in 3D labeling. Manually labeling point cloud data is therefore time-consuming, labor intensive, and costly. While some known systems mitigate scarcity of labeled data through pseudo labeling, these known systems require initial manual labeling of some point cloud data.

In contrast, systems and methods described herein address the above-described problems in at least some known systems and methods by pseudo labeling point clouds without manual labeling. Elimination of manual labeling greatly reduces time and costs in producing labeled data for developing autonomous computing systems. Point cloud data are typically sparse in data points and scarce with semantic information, rendering labeling point cloud data with semantic labels difficult. Systems and methods described herein integrate multi-modal sensor data in producing semantic labels in point clouds. For example, sensor data from a modality having semantic information, such as a camera modality, are integrated with point cloud data. To address the challenges from sparsity in data points, point cloud data are accumulated across temporal frames into a world map. Before accumulation, moving objects are removed to increase the accuracy in label generation. A labeled map of point clouds with semantic labels is generated by propagating labels derived from the modality having semantic information to the world map, thereby increasing the number of labeled points for point cloud data. To increase the accuracy of the labeled map, labels are propagated based on frequencies of semantic labels of points in the neighborhood.

Besides generating semantic labels for point clouds, systems and methods described herein are advantageous in providing additional labels of bounding boxes for moving objects and depth maps of increased accuracy, compared to at least some known methods. Before generating bounding boxes, moving objects are refined by removing false static points in the labeled map, thereby increasing the accuracy of the bounding boxes. As used herein, false static points refer to points incorrectly labeled as static in the labeled map, due to errors in the initial removal of moving objects in generating the world map and noise in the point cloud data. The removal of false static points is based on a frequency of a point appearing across the temporal frames of point clouds. The probability of a point being static may be adjusted based on the range of the point or the distance of the point from the sensor origin, such as the LiDAR sensor, thereby reducing errors in removing points distant from the sensor origin due to the relatively low signal to noise ratio (SNR) of distant points. The probability may also be adjusted based on the confidence level of labels in the labeled map. In generating depth maps based on the labeled map and the point cloud data, occluded points are removed, thereby increasing accuracy of the depth maps. Systems and methods described herein are advantageous in increasing the speed in the process of detecting and removing occluded points by using spherical coordinates during the process. Further, the threshold of removing occluded points is adjustable as a function of the range of a point, to reduce the likelihood of distant points being erroneously removed due to relatively low SNR.

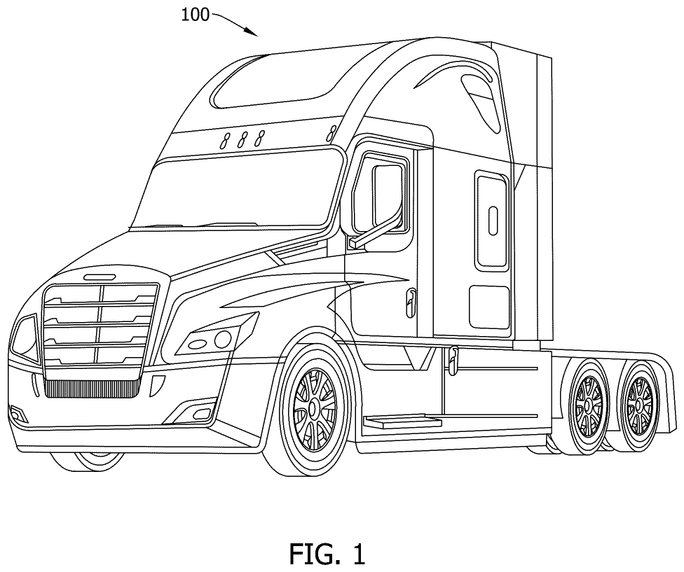

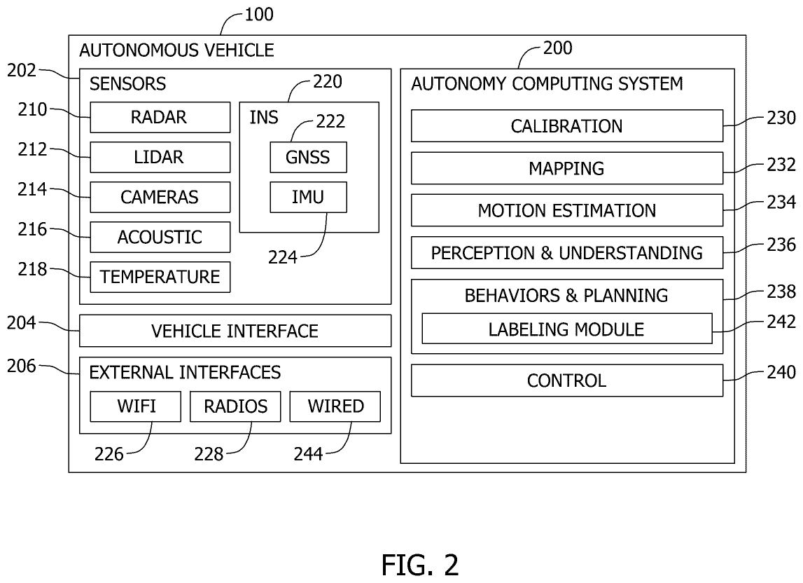

FIG. 1 is a schematic diagram of an autonomous vehicle 100. FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (radar) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 120 to determine how to control operation of autonomous vehicle 100.

Cameras 214 are configured to capture images of the environment surrounding autonomous vehicle 100 in any aspect or field of view (FOV). The FOV can have any angle or aspect such that images of the areas in front of, to the side of, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be stitched or combined to generate a visual representation of the multiple cameras' FOVs, which may be used to, for example, generate a bird's eye view of the environment surrounding autonomous vehicle 100. In some embodiments, the image data generated by cameras 214 may be sent to autonomy computing system 200 or other aspects of autonomous vehicle 100, and this image data may include autonomous vehicle 100 or a generated representation of autonomous vehicle 100. In some embodiments, one or more systems or components of autonomy computing system 200 may overlay labels to the features depicted in the image data, such as on a raster layer or other semantic layer of a high-definition (HD) map.

LiDAR sensors 212 generally include a laser generator and a detector that send and receive a LiDAR signal such that LiDAR point clouds (or “LiDAR images”) of the areas in front of, to the side of, behind, above, or below autonomous vehicle 100 can be captured and represented in the LiDAR point clouds. Radar sensors 210 may include short-range radar (SRR), mid-range radar (MRR), long-range radar (LRR), or ground-penetrating radar (GPR). One or more sensors may emit radio waves, and a processor may process received reflected data (e.g., raw radar sensor data) from the emitted radio waves. In some embodiments, the system inputs from cameras 214, radar sensors 210, or LiDAR sensors 212 may be fused or used in combination to determine conditions (e.g., locations of other objects) around autonomous vehicle 100.

GNSS receiver 222 is positioned on autonomous vehicle 100 and may be configured to determine a location of autonomous vehicle 100, which it may embody as GNSS data, as described herein. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, and or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically or manually) via external interfaces 206 or updated on demand. In some embodiments, autonomous vehicle 100 may deploy with all of the data it needs to complete a mission (e.g., perception, localization, and mission planning) and may not utilize a wireless connection or other connection while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and labeling module 242. Labeling module 242, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

Labeling module 242 receives data from one or more sensors, including at least one of point cloud data, image data, and Inertial Measurement Unit (IMU) data. Labeling module 242 performs initial processing on the received data, including pose detection, semantic segmentation, and Simultaneous Localization and Mapping (SLAM). Semantic labels are obtained from semantic segmentation on image data, while movement tags (e.g., whether a point is static or moving) are obtained from point cloud data. Semantic data are projected from sensors onto the world map obtained from the SLAM method. Labeling module 242 propagates labels based on probabilities to the world map and generate a labeled map. Labeling module 242 further refines the labeled map to remove any floating points or erroneous points using an iterative weighted update function that processes data from sensor scans, producing a refined labeled map. Labeling module 242 identifies moving objects by comparing sequential sensor scans to the refined world map. Detected moving objects are transformed into bounding boxes using the detected pose from pose detection, which may include a pose estimation from the SLAM method, the bounding boxes including a trajectory of the object including yaw dynamics. Labeling module 242 is also configured to remove occluded points and generate depth maps with increased accuracy. Labeling module 242 outputs the labeled map, bounding boxes of moving objects, and/or depth maps. Labeling module 242 may be used to label point cloud data while autonomous vehicle 100 is operating.

Autonomy computing system 200 of autonomous vehicle 100 may be completely autonomous (fully autonomous), semi-autonomous, or with any level of autonomy. In one example, autonomy computing system 200 can operate under Level 5 autonomy (e.g., full driving automation), Level 4 autonomy (e.g., high driving automation), Level 3 autonomy (e.g., conditional driving automation), Level 2 autonomy (e.g., partial driving automation), or Level 1 autonomy (e.g., driver assistance). As used herein the term “autonomous” includes fully autonomous, semi-autonomous, or having any level of autonomy.

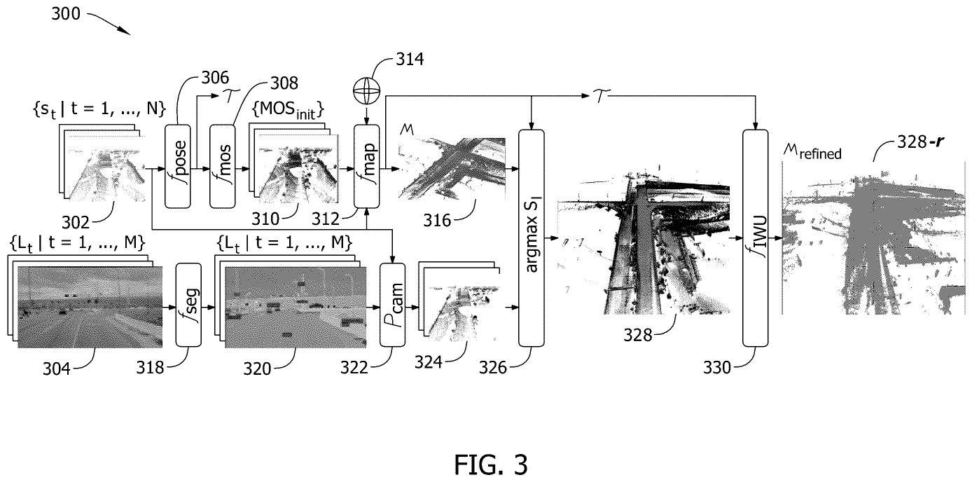

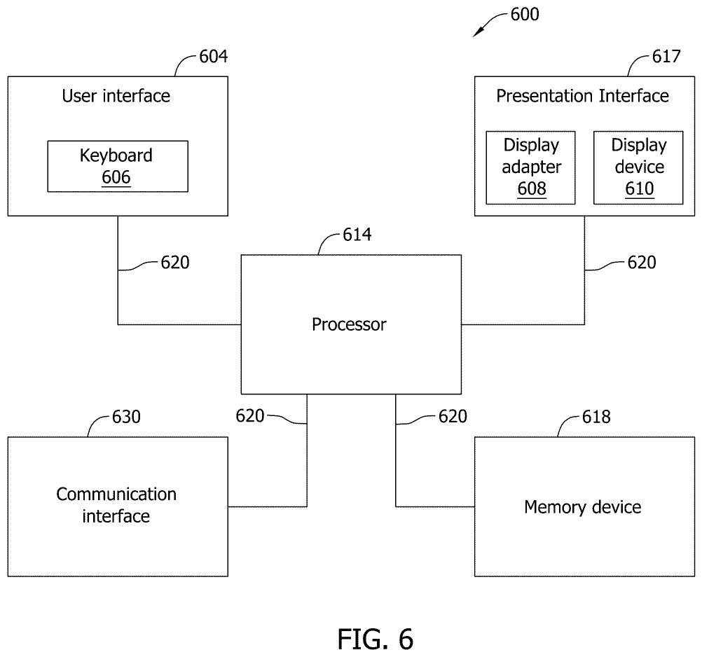

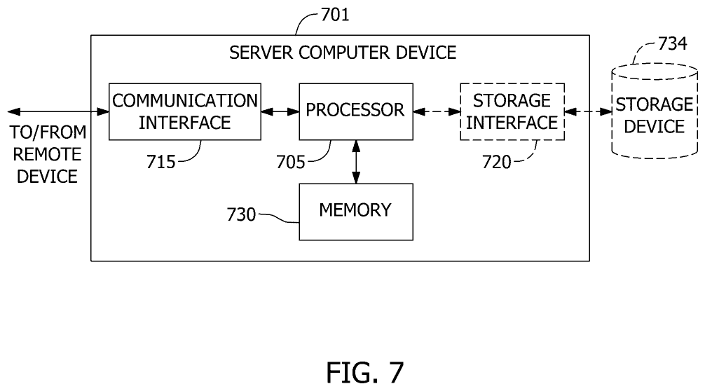

FIG. 3 is a schematic diagram of an example pseudo-label generation computing device 300. Pseudo-label generation computing device 300 may be implemented as a user computing device 600 (see FIG. 6, described later) or a server computing device 701 (see FIG. 7, described later). In some embodiments, pseudo-label generation computing device 300 may be implemented on autonomy computing system 200 as labeling module 242.

In the example embodiment, pseudo-label generation computing device 300 receives first sensor data 302 and second sensor data 304 of the environment in which the autonomous vehicle could operate. First sensor data 302 is in the modality of a 3D point cloud, for example, being LiDAR data. Second sensor data 304 is in the modality of images containing semantic information, for example, camera data. In some embodiments, other modalities or formats of received data are used. First sensor data 302 and second sensor data 304 may be retrieved from a database or a web application providing datasets. In some embodiments, first sensor data 302 and second sensor data 304 are received from sensors 202.

In the example embodiment, after pseudo-label generation computing device 300 receives first sensor data 302, pseudo-label generation computing device 300 estimates a sensor pose 306 based on first sensor data 302. Sensor pose 306 includes data relating to the absolute and relative position of the sensor or vehicle.

In the example embodiment, using first sensor data 302, pseudo-label generation computing device 300 performs moving object segmentation 308 to determine whether points in first sensor data 302 are classified as “moving” or “non-moving” to provide movement tags for the point. After moving object segmentation 308 is performed, pseudo-label generation computing device 300 outputs first sensor data 302 as a point cloud containing the preliminary movement tags. Preliminary movement tags are used to remove points labeled as moving objects and produce static first sensor data 310, with moving objects filtered out.

In the example embodiment, pseudo-label generation computing device 300 uses a mapping function 312 to generate a world map of first sensor data 302 by taking in static first sensor data 310 and/or inertial measurement unit data 314 as inputs to perform mapping function 312, and accumulating static first sensor data 310 into a world map 316. Mapping function 312 generates world map 316 based on first sensor data 302, preliminary movement tags, and inertial measurement unit data 314. Removal of moving points in static first sensor data 310 reduces errors caused by moving objects and enables construction of a world map with increased consistency and reliability. In some embodiments, static first sensor data augments data from another mapping function, such as a Simultaneous Localization and Mapping (SLAM) function.

In the example embodiment, using second sensor data 304, labeling module performs semantic segmentation 318 to obtain second semantic maps 320 based on second sensor data 304. Second semantic maps 320 include semantic labels of objects in the environment (e.g. “car”, and “sign”).

In the example embodiment, pseudo-label generation computing device 300 then generates first semantic maps 324 of the first modality based on second semantic maps 320. To obtain first semantic maps 324, pseudo-label generation computing device 300 uses a projection function 322 to align and project scans of first sensor data 302 into the temporal-matching scan of second sensor data 304 to generate 2D projected sensor data. In the projected sensor data, semantic labels from second semantic maps 320 are associated with the corresponding points in first sensor data 302 to generate projected semantic maps. The projected sensor data is then projected back to 3D to generate first semantic maps 324 of the first modality. In some embodiments, generating first semantic maps 324 includes labeling only visible points in the projected sensor data. To assess point visibility, pseudo-label generation computing device 300 determines a visibility mask for each pixel by comparing the depth of a point with the minimum depth of points in neighborhood. If the depth is within a threshold value, the point is marked as visible. By applying the visibility map to the projected sensor data, visible points receive semantic labels based on second sensor data 304, while points that are occluded from the sensors are left as unlabeled. Projected sensor data is output including the semantic data from semantic maps 320 and the depth information from first sensor data 302. Labeling only visible points improves efficiency and reduces computing overhead, while projecting and re-projecting the data permits generation of the first semantic maps 324 using both depth information from first sensor data 302 and semantic information from second sensor data 304.

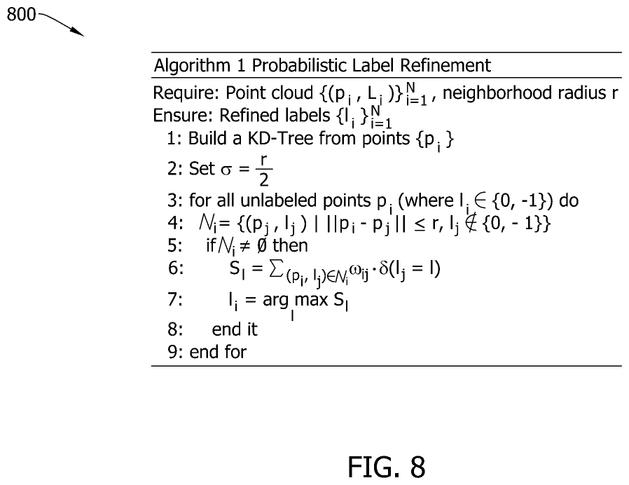

In the example embodiment, pseudo-label generation computing device 300 propagates semantic labels from first semantic maps 324 into world map 316 to generate a labeled map 328. In one example, an argmax function 326 is used. Argmax function 326 propagates labels from first semantic maps 324 into world map 316, where the semantic labels in first semantic maps 324 are propagated to unlabeled points in world map 316 by assigning a semantic label for a point in the point clouds of world map 316 based on frequencies or probabilities of semantic labels of points in a neighborhood of the point. For example, if an unlabeled point has 5 points in the neighborhood, 3 of which are labeled as “car”, and 2 of which are labeled as “sign”, the label of “car” would be propagated to the unlabeled point based on the quantity of the “car” label points being higher. In some embodiments, the frequencies may be weighted by a function of the distances of those points in the neighborhood from the point and/or the distribution of the distances. See also algorithm 1 in FIG. 8 (described later) for a more detailed example of the propagation algorithm 800. Pseudo-label generation computing device 300 outputs labeled map 328, which is world map 316 propagated with labels from first semantic maps 320.

In the example embodiment, labeled map 328 is further refined to generate a refined labeled map 332 by removing false static points. Removal of false static points is performed using an iterative weighted update function 330 to compare first sensor data 302 in temporal frames with labeled map 328, removing false static points in labeled map 328. False static points include floaters, which are moving points but erroneously determined as static, or errors due to the low SNR of distant points from the sensor origin. Pseudo-labeling computing device 300 removes false static points in labeled map 328 based on a probability that a point is static. The probability may be determined as frequency of observations of the point in sensor data across temporal frames of first sensor data 302. In some embodiments, the probability may be (i) adjusted a based on a range of the point, wherein the range is a distance of the point from a sensor origin, and/or (ii) adjusted based on a label influence factor associated with a confidence level of the label of the point. For example, pseudo-label generation computing device 300 determines the probability of the point being static based on the frequency of observations of the point in sensor data by comparing sequential scans of first sensor data 302 across temporal frames with labeled map. If the frequency of the point observed in sequential scans of sensor data is relatively low, it is likely that the point is a moving point, and the point is removed.

In the example embodiment, in another example, pseudo-label generation computing device 300 adjusts the probability that the point is static based on the distance from the point to the sensor to prevent distant static points from being incorrectly removed during the removal of false static points. Distant static points from the sensor are more likely to be incorrectly removed due to the relatively low SNR of distant points.

In the example embodiment, in one more example, pseudo-label generation computing device 300 adjusts the probability of the point being static based on a label influence factor associated with a confidence level of a labeled point. For example, if a label indicating that a point is static, such as a label of “tree,” has a high confidence level (e.g., it is 99% certain that a point is a “tree”), then the point is given an increased weight in determining if the point is static.

In the example embodiment, after the removal of false static points, the result is a refined labeled map 332. By adjusting probabilities and thresholds based on factors likely to cause error using the label influence factor and the distance from the sensor origin, the accuracy in determining false static points is improved, and likelihood of erroneous removals is reduced.

In the example embodiment, refined labeled map 332 is further used to generate bounding boxes for the moving objects. Pseudo-label generation computing device 300 uses pose 306 to align sequential scans sensor data with refined labeled map 332. Then, pseudo-label generation computing device 300 identifies moving objects in the first sensor data by comparing the aligned first sensor data 302 with the refined labeled map 332, and identifies a point as moving based on comparison using an adjustable threshold as a function of at least one of i) a distance of the point from its nearest neighbor in labeled map 328or ii) a range at the point in labeled map 328. Identifying moving objects using an adjustable threshold takes into account neighbors of a point and the distance of the point from the sensor origin, thereby improving the accuracy of determination of whether a point is moving, reducing the likelihood that static points are erroneously determined to be moving.

In the example embodiment, pseudo-label generation computing device 300 determines one or more clusters of moving points based on the threshold, and generates bounding boxes based on the identified moving objects. Bounding boxes may further be determined using object trajectories, for example, by determining object trajectories using principal component analysis (PCA) and using filters to reduce discrepancy in object trajectories over time.

In the example embodiment, Pseudo-label generation computing device 300 further produces depth maps based on refined labeled map 328-r. Pseudo-label generation computing device 300 generates a depth map based on refined labeled map 332 by reintroducing moving objects into labeled map 328 using pose 306 and removing occluded points from the labeled map using a spherical coordinates system. Pseudo-label generation computing device 300 removes the occluded points using an adjustable threshold as a function of a range at a point in the labeled map. Occluded points are removed from refined labeled map 328-r, and updated refined labeled map 328-r is output as a densified labeled 3D point cloud, containing all the data of refined labeled map 328-r with occluded points removed. The output labeled map is used to generate depth maps of increased accuracy.

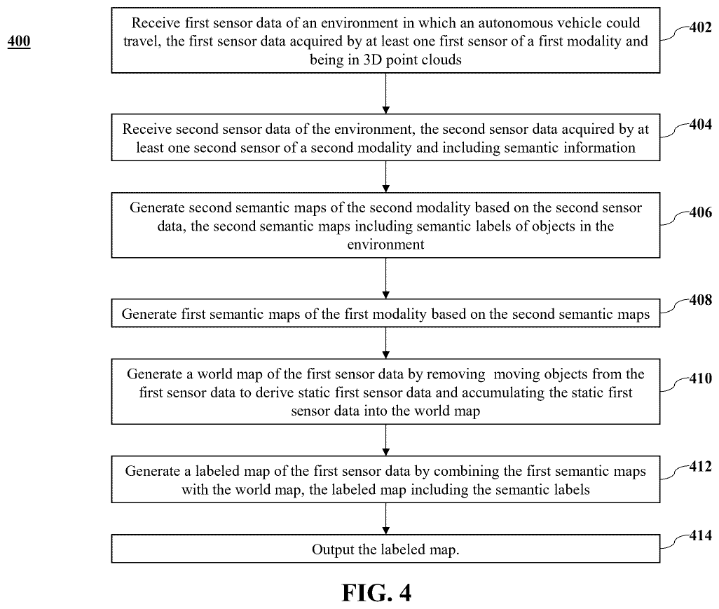

FIG. 4 is method flowchart showing an example method 400 of generating pseudo labels. Method 400 includes receiving 402 first sensor data of an environment in which an autonomous vehicle could travel, the first sensor data acquired by at least one first sensor of a first modality and being in 3D point clouds.

In the example embodiment, method 400 further includes receiving 404 second sensor data of the environment, the second sensor data acquired by at least one second sensor of a second modality and including semantic information.

In the example embodiment, method 400 further includes generating 406 second semantic maps of the second modality based on the second sensor data, the second semantic maps including semantic labels of objects in the environment.

In the example embodiment, method 400 further includes generating 408 first semantic maps of the first modality based on the second semantic maps.

In the example embodiment, method 400 further includes generating 410 a world map of the first sensor data by removing moving objects from the first sensor data to derive static first sensor data; and accumulating the static first sensor data into the world map.

In the example embodiment, method 400 further includes generating 412 a labeled map of the first sensor data by combining the first semantic maps with the world map, the labeled map including the semantic labels.

In the example embodiment, the method 400 further includes outputting 414 the labeled map.

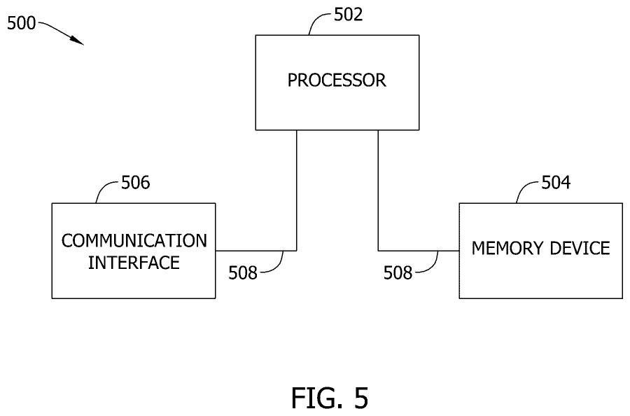

FIG. 5 is a block diagram of an example computing device 500 computing device 500. Autonomy computing system 200 may be implemented with one or more computing devices 500. Computing device 500 includes a processor 502 and a memory device 504. The processor 502 is coupled to the memory device 504 via a system bus 508. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are example only, and thus are not intended to limit in any way the definition or meaning of the term “processor.”

In the example embodiment, the memory device 504 includes one or more devices that enable information, such as executable instructions or other data (e.g., sensor data), to be stored and retrieved. Moreover, the memory device 504 includes one or more computer readable media, such as, without limitation, dynamic random access memory (DRAM), static random access memory (SRAM), a solid state disk, or a hard disk. In the example embodiment, the memory device 504 stores, without limitation, application source code, application object code, configuration data, additional input events, application states, assertion statements, validation results, or any other type of data. The computing device 500, in the example embodiment, may also include a communication interface 506 that is coupled to the processor 502 via system bus 508. Moreover, the communication interface 506 is communicatively coupled to data acquisition devices.

In the example embodiment, processor 502 may be programmed by encoding an operation using one or more executable instructions and providing the executable instructions in the memory device 504. In the example embodiment, the processor 502 is programmed to select a plurality of measurements that are received from data acquisition devices.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

FIG. 6 is a block diagram of an example user computing device 600. Systems and methods described herein may be implemented with one or more user computing devices 600 and software implemented therein. In the example embodiment, computing device 600 includes a user interface 604 that receives at least one input from a user. User interface 604 may include a keyboard 606 that enables the user to input pertinent information. User interface 604 may also include, for example, a pointing device, a mouse, a stylus, a touch sensitive panel (e.g., a touch pad and a touch screen), a gyroscope, an accelerometer, a position detector, and/or an audio input interface (e.g., including a microphone).

Moreover, in the example embodiment, computing device 600 includes a presentation interface 617 that presents information, such as input events and/or validation results, to the user. Presentation interface 617 may also include a display adapter 608 that is coupled to at least one display device 610. More specifically, in the example embodiment, display device 610 may be a visual display device, such as a cathode ray tube (CRT), a liquid crystal display (LCD), a light-emitting diode (LED) display, and/or an “electronic ink” display. Alternatively, presentation interface 617 may include an audio output device (e.g., an audio adapter and/or a speaker) and/or a printer.

Computing device 600 also includes a processor 614 and a memory device 618. Processor 614 is coupled to user interface 604, presentation interface 617, and memory device 618 via a system bus 620. In the example embodiment, processor 614 communicates with the user, such as by prompting the user via presentation interface 617 and/or by receiving user inputs via user interface 604. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are for illustration purposes only, and thus are not intended to limit in any way the definition and/or meaning of the term “processor.”

In the example embodiment, memory device 618 includes one or more devices that enable information, such as executable instructions and/or other data, to be stored and retrieved. Moreover, memory device 618 includes one or more computer readable media, such as, without limitation, dynamic random access memory (DRAM), static random access memory (SRAM), a solid state disk, and/or a hard disk. In the example embodiment, memory device 618 stores, without limitation, application source code, application object code, configuration data, additional input events, application states, assertion statements, validation results, and/or any other type of data. Computing device 600, in the example embodiment, may also include a communication interface 630 that is coupled to processor 614 via system bus 620. Moreover, communication interface 630 is communicatively coupled to data acquisition devices.

In the example embodiment, processor 614 may be programmed by encoding an operation using one or more executable instructions and providing the executable instructions in memory device 618. In the example embodiment, processor 614 is programmed to select a plurality of measurements that are received from data acquisition devices.

In operation, a computer executes computer-executable instructions embodied in one or more computer-executable components stored on one or more computer-readable media to implement aspects of the invention described and/or illustrated herein. The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

FIG. 7 illustrates an example configuration of a server computer device 701. Systems and methods described herein may be implemented with one or more server computer devices 701. In the example embodiment, server computer device 701 also includes a processor 708 for executing instructions. Instructions may be stored in a memory area 730, for example. Processor 708 may include one or more processing units (e.g., in a multicore configuration).

Processor 708 is operatively coupled to a communication interface 718 such that server computer device 701 is capable of communicating with a remote device or another server computer device 701. For example, communication interface 718 may receive data from a system such as autonomy computing system 200, via the Internet.

Processor 708 may also be operatively coupled to a storage device 734. Storage device 734 is any computer-operated hardware suitable for storing and/or retrieving data. In some embodiments, storage device 734 is integrated in server computer device 701. For example, server computer device 701 may include one or more hard disk drives as storage device 734. In other embodiments, storage device 734 is external to server computer device 701 and may be accessed by a plurality of server computer devices 701. For example, storage device 734 may include multiple storage units such as hard disks and/or solid state disks in a redundant array of independent disks (RAID) configuration. storage device 734 may include a storage area network (SAN) and/or a network attached storage (NAS) system.

In some embodiments, processor 708 is operatively coupled to storage device 734 via a storage interface 720. Storage interface 720 is any component capable of providing processor 708 with access to storage device 734. Storage interface 720 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 708 with access to storage device 734.

### Example 1

The pseudo-labeling approach operates on point cloud measurements. To devise a method that is agnostic to datasets, sensor configurations, and domains, leverage foundational models and integrate probabilistic constraints derived from the geometry in accumulated scene maps. As illustrated in FIG. 1, starting from raw sets of images/={Iₜ|Iₜ∈ [symbol] ^{H×W×3} t=1, . . . , M}, point clouds S={sₜ|t=1, . . . , N} and IMU measurements, first initialize low-confidence moving and semantic labels through camera-to-point cloud projection. Subsequently, iterate through the map to distinguish between static and dynamic elements of the environment, augmenting the probability distribution with additional observations. After this Iterative Weighted Update, extract a statistically refined map to be decomposed in a densely distributed set of 3D points annotated with semantic labels, alongside sparse observations for moving objects.

An initial estimate of the pose is obtained by applying a point cloud odometry method ƒₚₒₛₑ to a sequence of point cloud scans. Specifically, given a set of point cloud scans S={sₜ|t=1, . . . , N}, the pose estimation function computes a corresponding set of transformation matrices T={Tₜ∈SE(3)}, representing the rotation and translation between frames, such that T=ƒₚₒₛₑ(S). To identify moving objects, apply a moving object segmentation function ƒₘₒₛ: at this preliminary stage, the objective is to acquire an initial estimation of moving objects MOSᵢₙᵢₜ=ƒₘₒₛ(T), rather than achieving perfectly accurate segmentation. The process can be formalized as:

$$S {\to }^{{f}_{pose}} T {\to }^{{f}_{mos}} {MOS}_{init}$$

### Camera Branch Semantic Labels Initialization

Given a set of images I={Iₜ|Iₜ∈ [symbol] ^{H×W×3}, t=1, . . . , M}, where H and W represent the image height and width, respectively, map each input RGB image Iₜ to a per-pixel label image Lₜ=ƒ_{seg}(Iₜ), where ƒ_{seg}: [symbol] ^{H×W×3}→ [symbol] ^{H×W}, Lₜ=Lₜ(u, v)∈ [symbol] for each pixel (u, v), and L is a set of unique integers representing specific object classes (e.g. “car”: 10, “bicycle”: 11, “vegetation”: 70, . . . ). As the variety of annotations increases, detailed descriptions and conjugations are disregarded in order to limit the number of classes. Upon projecting the point cloud into the best temporal-matching image, for each valid pixel (u, v) of the depth image, the visibility mask M(u, v) is determined by comparing the depth with the minimum depth in its neighborhood N(u, v). If the depth value is within a threshold t, the point is marked as visible.

$$M ( u , v ) = \{ \begin{matrix}1 & if D ( u , v ) \leq min ( D ( N ( u , v ) ) + τ \\ 0 & otherwise\end{matrix}$$

Let

$$( {u}_{i}^{{p}_{i}} , {v}_{i}^{{p}_{i}} )$$

be the pixel coordinates of a projected point cloud point pᵢ. The corresponding label lᵢ for each point is given by

$$li = \{ \begin{matrix}L ( {u}_{i} , {v}_{i} ) & if M ( {u}_{i} , {v}_{i} ) = 1 \\ None & if M ( {u}_{i} , {v}_{i} ) = 0\end{matrix}$$

This ensures that only visible points receive labels, while occluded points are not labeled. In those regions in which overlapping cameras are available, store the information about all the observations, in order to filter out wrong segmentation, if different labels are assigned from different camera views, or enhance correct segmentation, if the same label is assigned.

### SLAM Mapping

To accumulate a consistent 3D map and achieve more accurate pose estimation, run a LiDAR-inertial odometry and mapping method ƒₘₐₚ. Instead of using the set of raw scans S, the point clouds are first preprocessed to remove points labeled as moving objects,

$${S}_{static} = \{ {s}_{t}^{static} = {s}_{t}^{static} ∖ {mos}_{t} , {s}_{t} ∈ S , {mos}_{t} ∈ {MOS}_{init} \} ,$$

which filters out dynamic elements that could degrade mapping performance. By excluding these points, the algorithm focuses on static features of the environment, enabling the reliable construction of a consistent map even in scenes with high dynamic activity. The remaining static points are then used to perform scan matching and pose graph optimization, further refining the pose estimates and the map structure, (M, T′)=ƒₘₐₚ (S_{static}, I).

### Geometry Consistent Voting

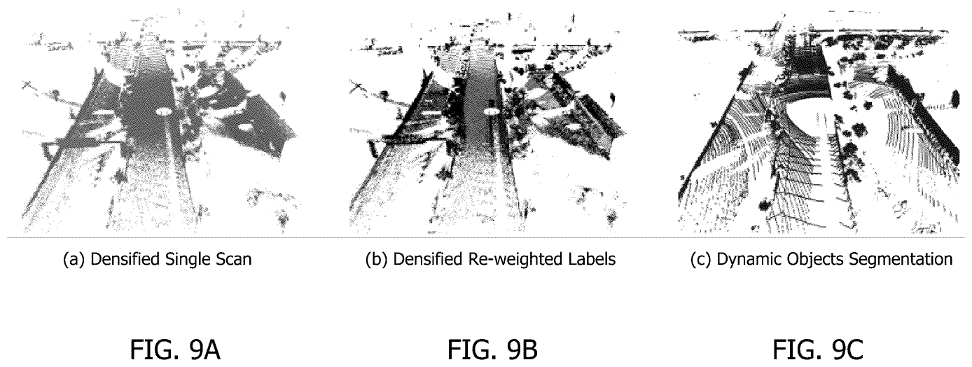

Differentiate the world into static and dynamic objects and include a geometry-grounded method to iteratively refine the static world representation by enforcing both spatial and semantic consistency and extracting temporally moving objects as outliers, proving a moving object segmentation. This process enables generation of several valuable outputs, including ground truth geometry from densified point cloud scans with 360-degree semantic labels and robust moving object segmentation, as presented in FIG. 9.

### Semantic Multimodal Propagation

Referring now to FIG. 8, by sequentially associating each point label of a point cloud scan to the correspondent point in the map, project the semantics from each camera into the world map. As a result, each point in the map then is be represented as pi=(xᵢ, yᵢ, zᵢ, {(lᵢ₁, nᵢ₁), (lᵢ₂, nᵢ₂), . . . , (lᵢₘ_{ᵢ}, nᵢₘ_{ᵢ})}), where xᵢ, yᵢ, zᵢ, are the spatial coordinates and {(lᵢⱼ, nᵢⱼ)} is a set of label-count pairs associated with point i, and lᵢⱼ is the j-th label assigned to point pᵢ. nᵢⱼ is the number of times label lᵢⱼ was assigned pᵢ. See also Algorithm 1 in FIG. 4.

Here, mᵢ is the total number of unique labels assigned to point i. Propagate labels probabilistically in order to enhance segmented areas and fill gaps in the map following the steps of Algorithm 1 as shown in FIG. 8. Here, set

$${w}_{i , j} = exp ( - \frac{{‖ {p}_{i} - {p}_{j} ‖}^{2}}{2 {σ}^{2}} ) ,$$

and δ(lⱼ=1) is the Kronecker delta, equal to 1 if lⱼ=l, and 0 otherwise.

### Map Refinement

To further refine the map from remaining floater and errors, an Iterative Weighted Update Function ƒ_{IWU} is used: by iteratively comparing the sparse point cloud with the map, points belonging to moving objects but mistakenly registered in the map are likely to be “hit” only once or twice by subsequent scans, as they are not consistently observed. Consequently, update the probability that each map point is static by considering the frequency of its observations, incorporating an influence factor based on distance. Since point cloud data can be very noisy and sparse in distant regions, many points are registered only once. To avoid incorrectly labeling these distant static points as dynamic due to noise and sparsity, adjust their probability updates accordingly, ensuring they are not unjustly marked as dynamic. For each point pⱼ∈sₜ, sₜ∈S, t=1, . . . , N, calculate the Euclidean distance dᵢⱼ to all map points mᵢ ∈M and from the sensor origin rⱼ with

$$dij = ‖ {p}_{j} - {m}_{i} ‖ , {r}_{j} = ‖ {s}_{j} ‖$$

Based on this distance, locate the nearest map point mi for each scan point sⱼ. If the distance dᵢⱼ is less than a specified threshold dₜₕᵣₑₛₕ, the static probability is updated through the j-th influence factor through:

$$r * j = min ( 1 , \frac{{r}_{max}}{{r}_{j}} )$$

If the scan point is within the threshold, the static probability is increased by:

$${P}^{k + 1} ( {\tilde{m}}_{i} ) = α \cdot {P}^{k} ( {\tilde{m}}_{i} ) + ( 1 - α ) \cdot {r}_{j}^{*}$$

If the scan point is outside the threshold, the static probability is decreased by:

$${P}^{k + 1} ( {\tilde{m}}_{i} ) = α \cdot {P}^{k} ( {\tilde{m}}_{i} ) + ( 1 - α ) \cdot ( 1 - {r}_{j}^{*} ) .$$

Exploit accumulated labels as a binary classification of the object nature L(mᵢ)∈{movable, non-movable}, together with their confidence score C(mᵢ)∈[0, 1]. Further introduce a label influence factor β≥0 to control the weighting of labels in the update. If the scan point is within the distance threshold, the static probability is updated as

$${P}^{k + 1} ( {\tilde{m}}_{i} ) = α \cdot {P}^{k} ( {\tilde{m}}_{i} ) + ( 1 - α ) \cdot {r}_{j}^{*} \cdot ( 1 + β \cdot C ( {\tilde{m}}_{i} ) )$$

If the scan point is outside the threshold, the static probability is updated as:

$${P}^{k + 1} ( {\tilde{m}}_{i} ) = α \cdot {P}^{k} ( {\tilde{m}}_{i} ) + ( 1 - α ) \cdot ( 1 - {r}_{j}^{*} ) \cdot ( 1 - β \cdot C ( {\tilde{m}}_{i} ) )$$

Here, C(\tilde{m}ᵢ) modulates the label's impact on the update. A high-confidence label increases the influence on the probability update, while a low-confidence label has a smaller effect. The factor β allows us to control how label confidence adjusts the influence factor, reducing the impact of low-confidence labels and preventing them from significantly affecting the probability updates.

### Moving Objects Refinement

Next, detect moving objects by comparing sequential point cloud scans to a static map. Given the set of scans S and the accumulated, consistent static map M_{refined}, simple subtraction between the two would reveal moving objects based on direct comparison: this involves aligning the sparse point cloud to the map M_{refined}, using the pose, and finding for each point pᵢ the closest point on the map up to a certain threshold. This, however, does not take into account the nature of the points recorded in the map with ƒₘₐₚ, and the high sparsity level on further regions. Therefore, instead of using a fixed threshold, compute the Euclidean distance to its nearest neighbor in the static map rᵢ=∥pᵢ∥. The standard deviation σᵢ for each point is modeled as a function of its range (distance from the sensor origin): σᵢ=σ₀+k·rᵢ, where σ₀ is the base standard deviation at the origin, k is the rate at which σ increases with range, and rᵢ is the range of point pᵢ. The probability that a point is static is then calculated using the Gaussian probability density function

$${p}_{i} = exp ( - \frac{{d}_{i}^{2}}{2 {σ}_{i}^{2}} ) .$$

Points with probabilities exceeding a predefined threshold t are classified as static, while those below t are marked as moving.

### Bounding Boxes

To transform the moving object detections into bounding boxes, first exploit the pose estimation from the SLAM algorithm to align three consecutive scans, considering only the points labeled as moving, and then use Hierarchical Density-Based Spatial Clustering of Applications with Noise (HDBSCAN) to cluster them: feed the algorithm also semantic labels to get more accurate segmentation. Then fit the minimum enclosing cuboid for each cluster and directly assign a minimum bounding box size; use PCA to get an initial estimate of the yaw and use a Kalman Filter based tracker, with constant velocity model including yaw dynamics. Once trajectories are obtained, refine it using a spline optimization method. The yaw optimization aims to ensure that the estimated trajectory's orientation aligns with recorded yaw measurements by minimizing discrepancies in yaw over time. This is achieved by representing the yaw as a combination of basis functions, modeling both the sine and cosine components of the yaw angle, ψ. The objective of the yaw optimization is to minimize the following cost function, i_{yaw}, which penalizes the difference between the estimated and measured yaw directions:

$${e}_{y a w} = \frac{1}{2} {\sum }_{j} ( {( {f}_{c o s} ( {t}_{j} ) - cos ( {ψ}_{j} ) )}^{2} + {( {f}_{s i n} ( {t}_{j} ) - sin ( {ψ}_{j} ) )}^{2} ) ,$$

where ƒ_{cos}(t) and ƒₛᵢₙ(t) are the model's estimates for the cosine and sine of the yaw angle, represented as linear combinations of basis functions:

$${f}_{c o s} ( t ) = {\sum }_{k} {w}_{c o s , k} \cdot {f}_{k} ( t ) ,$$

$${f}_{s i n} ( t ) = {\sum }_{k} {w}_{s i n , k} \cdot {f}_{k} ( t )$$

ψⱼ is the measured yaw angle at each time tⱼ. The yaw angle at each time t can be reconstructed using the arctangent:

$$ψ ( t ) = arc tan 2 ( {f}_{s i n} ( t ) , {f}_{c o s} ( t ) )$$

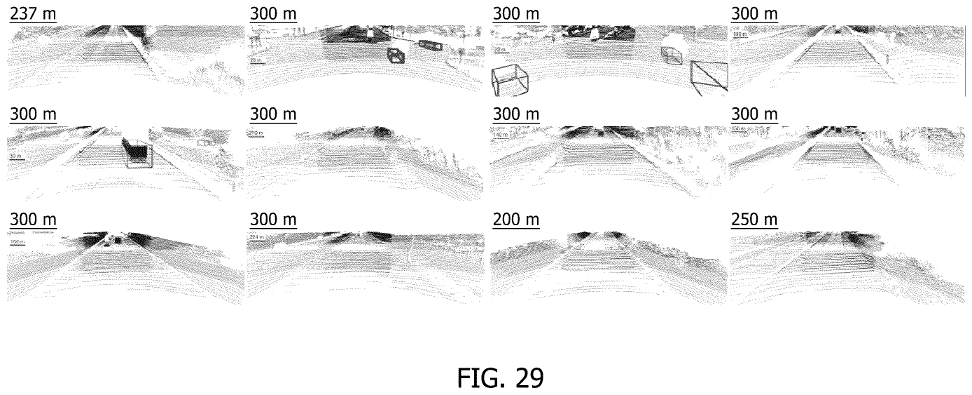

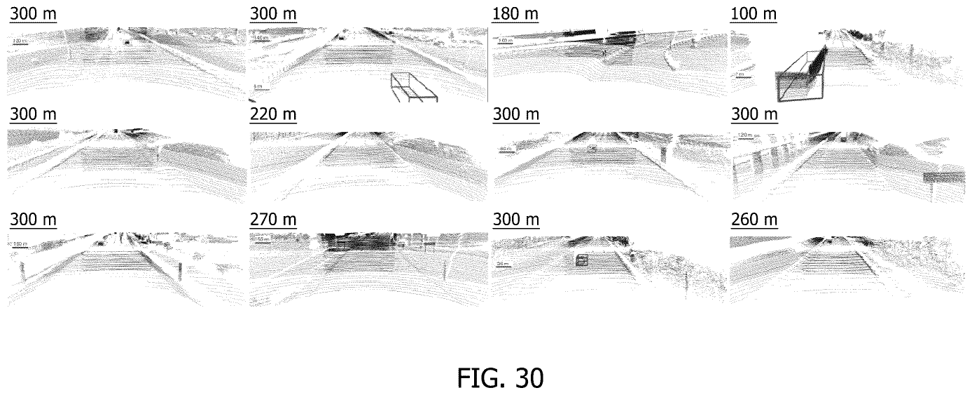

To enforce smooth, coherent motion, the second derivatives of ƒ_{cos} (t) and ƒₛᵢₙ(t) are modeled as first-order B-splines. This problem is then solved using quadratic optimization. Example bounding box outputs at various ranges can be seen in FIG. 29 and FIG. 30.

### High-quality Accumulated Depth.

Also produce high-resolution point cloud (e.g. LiDAR) frames from the accumulated map exploiting the pose T′ to reintroduce moving objects and transform the coordinate system: provided that occlusions are compensated for, produced are new single scans with twice the amount of points and higher density at longer ranges. To simulate the scanning pattern of a LiDAR, use an Adaptive Spherical Occlusion Culling to convert each point to spherical coordinates (r, θ, φ), define angular resolutions Δθ and Δφ, and create bins:

$${θ}_{b i n s} = \{ {θ}_{min} , {θ}_{min} + Δ θ , {θ}_{min} + 2 Δθ , … , {θ}_{max} \}$$

$${ϕ}_{b i n s} = \{ {ϕ}_{min} , {ϕ}_{min} + Δ ϕ , {ϕ}_{min} + 2 Δϕ , … , {ϕ}_{max} \}$$

In contrast to other methods, for each bin (i, j), find the minimum range

$${r}_{min}^{( i , j )} ,$$

that is:

$${r}_{min}^{( i , j )} , = min \{ {r}_{k} \vert k ∈ bin ( i , j ) \}$$

Define a threshold function T(r) that increases with range T(r)=1+αr, where α is a small positive constant. A point k in bin (i, j) is considered visible if

$${r}_{k} \leq {r}_{min}^{( i , j )} + T ( {r}_{k} ) ,$$

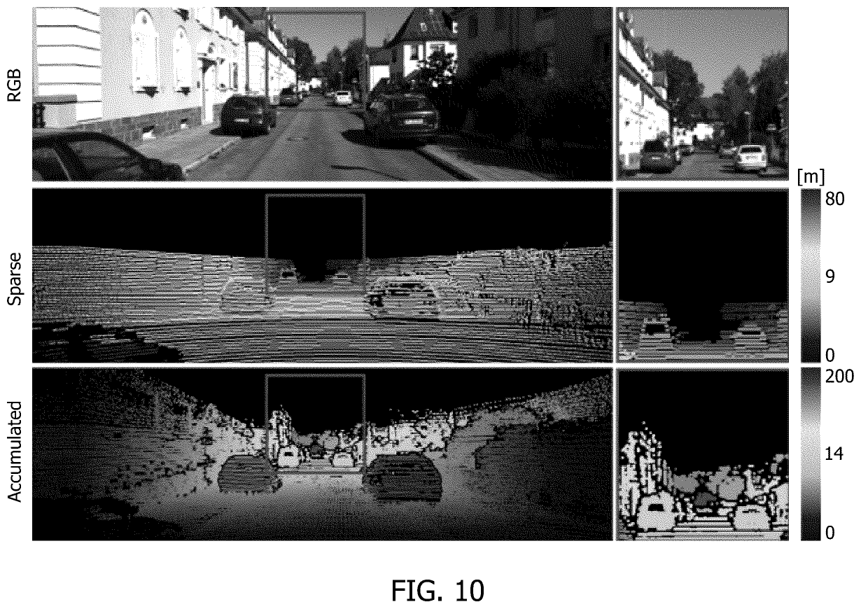

and otherwise, the point is considered occluded. This results in Densified 3D point cloud scans, visible in FIG. 9A-9C, that can enhance 2D supervision for depth estimation at any range, by enriching camera view more effectively than sparse LiDAR, as shown in FIG. 10.

FIG. 9A-9C show example embodiments of dynamic scene decomposition outputs. Given a single driving trajectory as input, the pseudo-label generation computing device 300 outputs, alongside bounding boxes, a decomposition of a scene into several components: densified multi-pose synesthetic point clouds in FIG. 9A are obtained upon accumulating a number of point cloud scans in the refined map and occluding points based on the current viewpoint. As the map also contains refined semantic re-weighted labels, these can be stored in the densified scan, retrieving an almost full 360 degree semantic observation, shown in FIG. 9B, As the refined map is cleaned of outliers and moving floaters, moving points can be identified and segmented back into the sparse scans, as shown in FIG. 9C.

### Experiments

The method is validated by assessing the quality of the produced pseudo-labels for three tasks: semantic segmentation, long-range depth prediction, and object detection. Evaluate the dataset on the KITTI dataset and an experimental long-range highway test dataset described further herein.

### Semantic Labels Evaluation

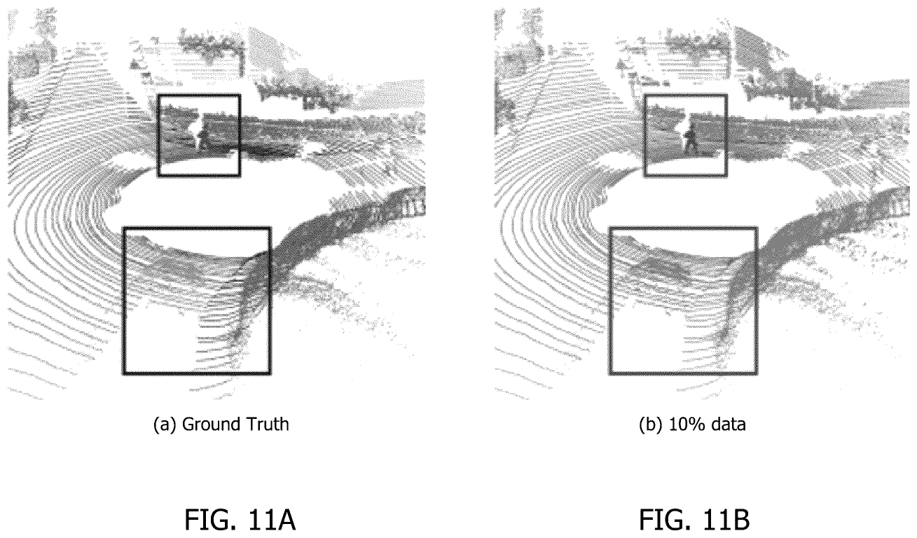

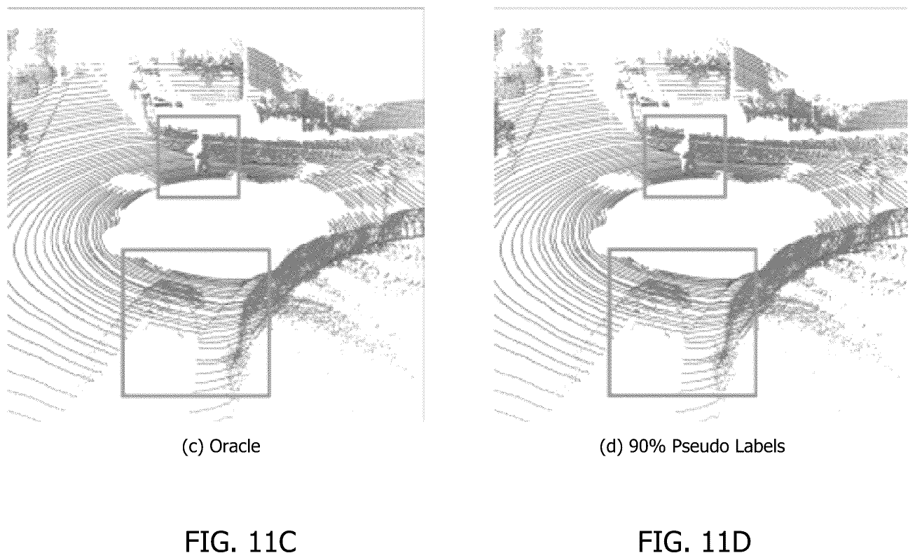

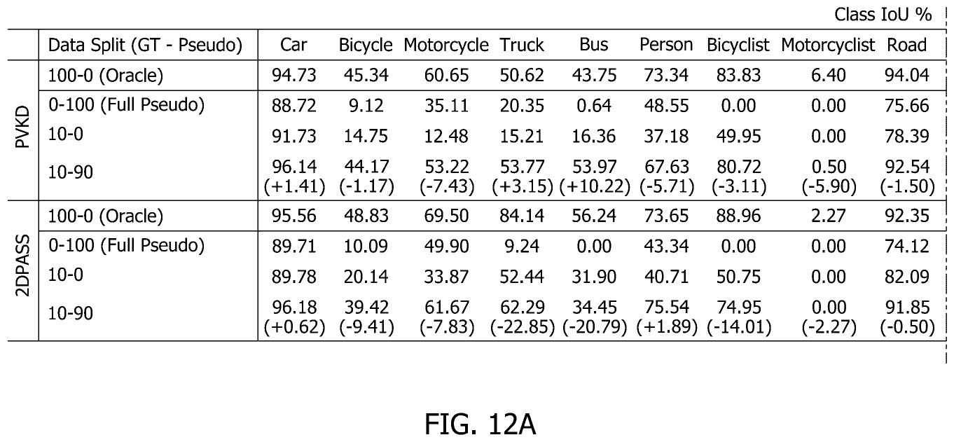

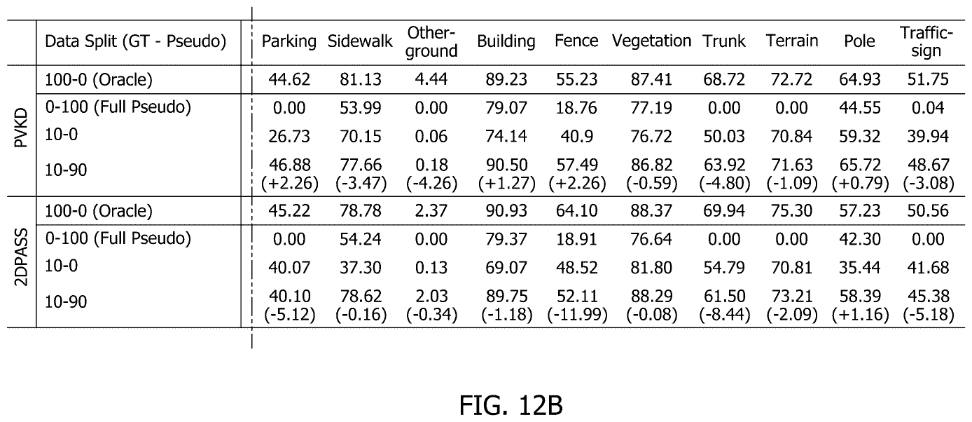

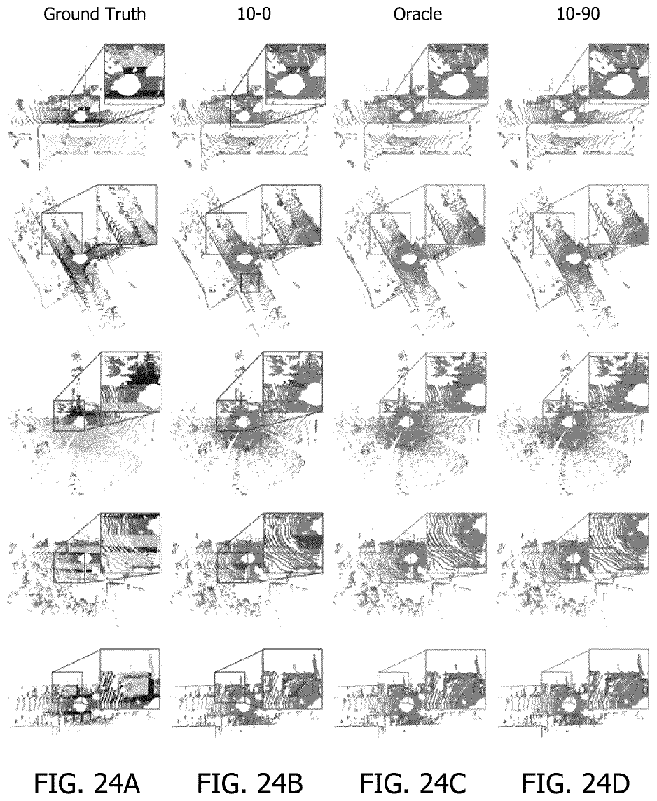

Semantic pseudo-labels are evaluated using the Semantic KITTI dataset. Initially, generate LiDAR semantic labels using only the front-left camera. To obtain 360-degree labels, re-align the sparse LiDAR scan with the final labeled map (see Section on Geometry-Consistent Voting, above). Since many classes are not mapped by ƒ_{seg}, focus evaluation only on the available classes, specifically excluding parking, bicyclist, motorcyclist, other-ground, other-objects, trunk, and terrain. From the Semantic KITTI leaderboard, select PVKD because its approach of distilling knowledge first through voxels and then through points aligns well with sparser observations. Additionally, choose 2D Priors Assisted Semantic Segmentation (2DPASS) as a more challenging model due to its use of 2D-3D fusion. Utilize the available vanilla training configurations with different modalities: Oracle (trained on 100% ground-truth data), Full Pseudo (trained on 100% pseudo labels), 10-0 (trained on only 10% of the dataset using ground truth data), and 10-90 (trained using 90% pseudo labels and the same 10% of ground truth labels as 10-0). To ensure accurate labeling in all directions, exclude the first 10 pseudo-labeled frames of each sequence because, unless the car revisits the starting point later in the sequence (as in a loop), these frames cannot be labeled in all directions. The results on evaluation sequence 08 are presented in the table shown in FIGS. 12A and 12B, highlighting the performance differences compared to the Oracle for the model trained with mixed supervision. For PVKD, the model trained with mixed supervision achieves near-Oracle quality, with a small average difference of −1.09%, as also proven in FIGS. 12A and 12B. When excluding the classes not mapped by the method used by pseudo-label generation computing device 300 from the averaging, this difference reduces further to −0.30%. For the more challenging 2DPASS, observed are average differences of −5.71% including the unmapped classes and −4.62% when excluding them. It appears that rarer classes are more penalized in this model, as higher differences occur in classes where the Full Pseudo model also struggles with segmentation. FIGS. 11A-11D demonstrate the effect of pseudo-labeling using pseudo-label generation computing device 300, showing that the quality of the 10-90 model with pseudo-labels is comparable to Oracle models. FIGS. 24A-24D show additional qualitative results for semantic segmentation, presenting additional results of predictions of the models trained respectively on 10% ground truth labels (10-0), on 100% ground truth labels (Oracle), and on 10% ground truth labels coupled with 90% of pseudo labels. As shown above, the addition of pseudo labels let the model achieve near-Oracle quality, confirming that pseudo-label generation computing device 300 can generate a valid additional ground truth for unlabeled datasets.

### Depth Evaluation

In order to assess depth, use both the short-range-LiDAR, small-baseline dataset KITTI and long-range-LiDAR, wide-baseline dataset and assess two recent models with and without the pseudo-labels: Neural Mark Random Field (NMRF) and Iterative Geometry Encoding Volume (IGEV) Stereo, which have demonstrated strong performance on the KITTI benchmark and good generalization capabilities. First, it is shown that the accumulated scans, with longer range, higher density, and precise removal of moving objects, enable model validation at broader ranges than a typical LiDAR scan, with reduced influence of random matchings due to the increased pixel count. Secondly, LiDAR depth supervision with the reverse Huber (berHu) loss are exploited after defining δ=|predᵢ−targetᵢ| and c=0.2*maxᵢ|predᵢ−targetᵢ|,

$${L}_{i} = \{ \begin{matrix}{δ}_{i} , & if {δ}_{i} < c , \\ \frac{( {δ}_{i}^{2} + {c}^{2} )}{2 c} , & if {δ}_{i} \geq c ,\end{matrix} , ℒ = \frac{1}{N} {\sum }_{i = 1}^{N} {L}_{i}$$

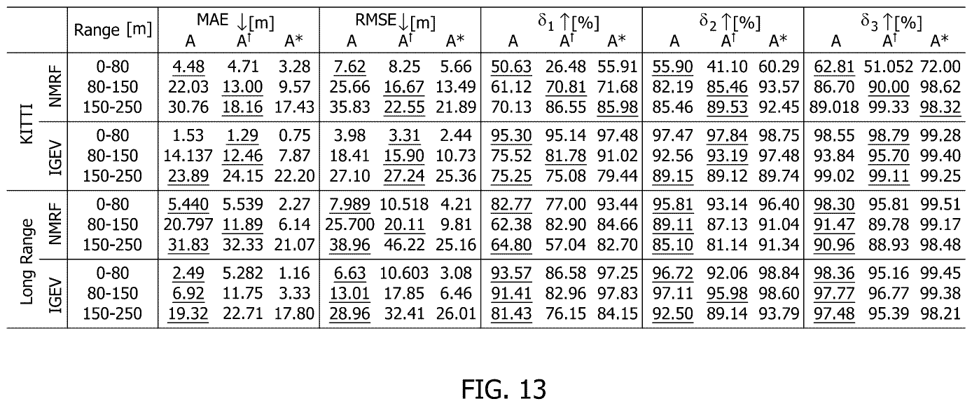

The above is used to fine-tune the models and validate the improvements at the same ranges. Since both models predict disparity, convert their predictions to depth and compute the Mean Absolute Error (MAE), Root Mean Squared Error (RMSE), and the threshold accuracy metric δᵢ<1.25ⁱ for i∈1, 2, 3 on the pixels where ground truth is available. All results are shown in FIG. 13. As generating high-density maps is conventionally done using LiDAR Inertial Odometry algorithms, also fine-tune the models on a ground truth generated from a tightly-coupled LiDAR inertial odometry via smoothing and mapping and, without the Adaptive Spherical Occlusion Culling and floaters refinement and use them as a further baseline method.

### Short Range Dataset

Randomly sample a training set and an evaluation set from the Semantic KITTI training dataset. To evaluate the NMRF model, first assess its published pre-trained version, which has been fine-tuned on a different set of stereo pairs from the KITTI dataset, with sparse supervision. Using a test split, compare its predictions against the ground truth generated from the accumulated LiDAR data. Then fine-tune the model-initially trained solely on synthetic data from the Conference on Computer Vision and Pattern Recognition (CVPR)-using 400 stereo pairs for 30,000 steps on the training split. The results are shown in the table in FIG. 13, observing an improvement of 26.79%, 56.56% and 43.34% in MAE and 25.73%, 47.43%, 38.88% in RMSE for 0-80 m, 80-150 m, 150-250 m ranges respectively. Moreover, improvements of 30.38%, 26.38% and 4.02% in MAE and 31.39%, 19.07% and 2.92% in RMSE are achieved compared to the baseline model (A†). For IGEV-Stereo, train on the same 400 stereo pairs until convergence and observe an improvement of 50.98%, 44.31% and 7.07% in MAE and 38.69%, 41.77%, 6.42% in RMSE for 0-80 m, 80-150 m, 150-250 m ranges respectively. Moreover, improvements of 41.86%, 36.84% and 8.07% in MAE and 26.28%, 32.56% and 6.90% in RMSE are achieved compared to the reference model (A†).

### Object Detection Evaluation

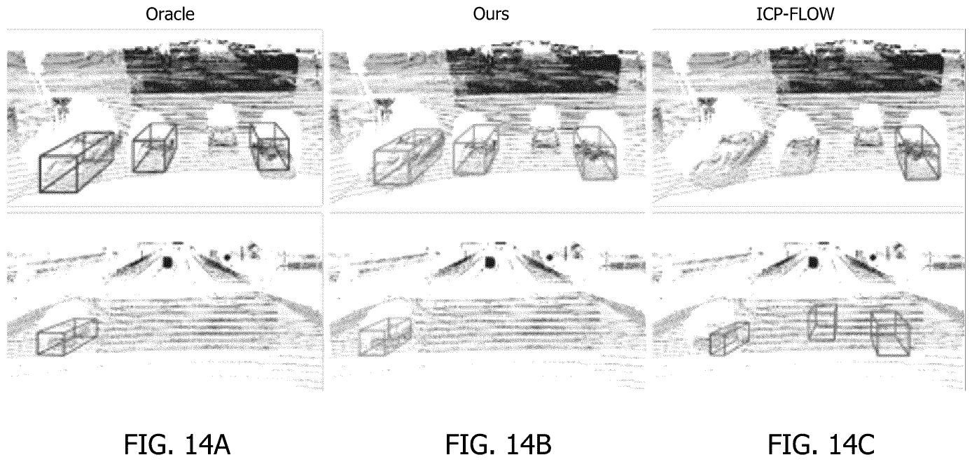

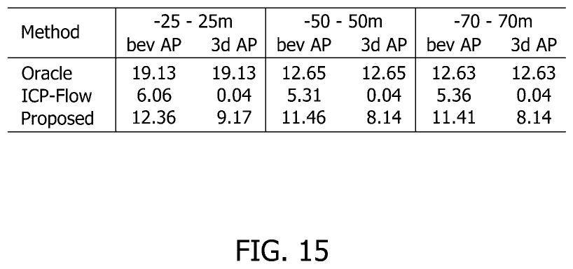

Referring now to FIG. 14A-14C, the figures show an evaluation object detection by training an off-the-shelf 3D detector on full ground truth (Oracle) and on 20% ground truth labels and 80% pseudo labels (Pseudo). Compare this method by training the detector also on pseudo bounding boxes generated using Iterative Closest Point Flow (ICP-Flow), as it showed a very effective way of generating pseudo labels without relying on manual annotations: to do this, convert the flow estimation in moving objects segmentation, if the estimated speed is greater than 1 m/s, and generate bounding boxes with the same approach followed herein. The results are reported in FIG. 15, where it is shown how the pseudo labels can achieve Oracle performances compared to other effective pseudo labeling methods, which introduce unrecoverable errors in training, qualitatively shown FIG. 15.

### Example 2

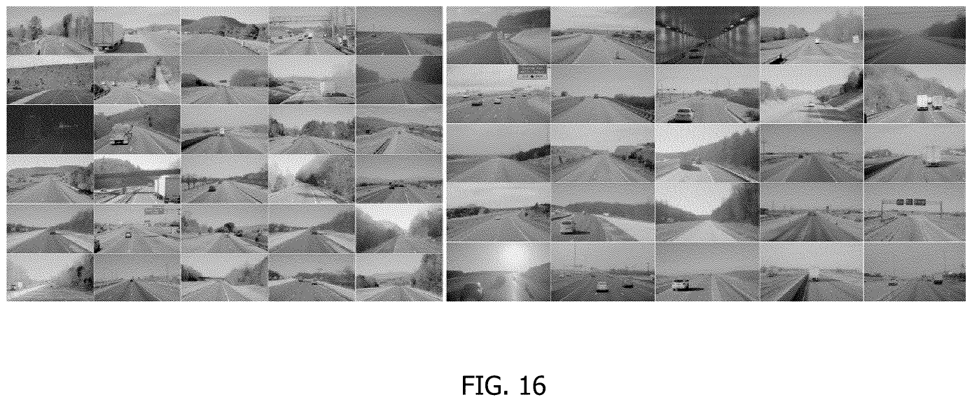

Datasets used herein are generated by capturing and processing a comprehensive long-range dataset specifically for long-haul trucking. Existing public datasets predominantly rely on short-range LiDAR sensors with maximum ranges of approximately 70 to 80 meters. While these datasets have been instrumental in advancing perception algorithms, the limited range of existing LiDAR sensors can constrain a vehicle's ability to detect and respond to distant objects, especially at higher speeds. The long-range LiDAR datasets used herein provide valuable data for developing and testing algorithms capable of identifying obstacles, traffic signs, and other vehicles from greater distances, as well as allowing deeper depth cues for depth prediction networks. This is crucial for improving the safety and efficiency of autonomous driving systems, enabling better decision-making and longer reaction times in dynamic and complex driving environments. A long-range dataset is acquired from diverse locations in Texas, New Mexico, and Virginia, mainly focusing on highway scenarios to allow long-range perception distances. All sensors are mounted on a semi-truck within a sensor module positioned on top of the driver cabin. The cameras used in this dataset are OnSemi AR0820 models, featuring ½-inch complementary metal-oxide semiconductor (CMOS) sensors that capture raw data in RCCB format. This setup includes synchronized AR0820 cameras recording a near 360° view at 5 Hz with a resolution of 3848×2168 pixels. For the LiDAR sensors, relied upon are 4D LiDARs and the AEVA AERIS II, capable of directly measuring radial velocity for each LiDAR point. They captures data at 10 Hz, with a range of up to 400 m and are as well displayed to cover 360 degrees around the semi-truck. The camera-LiDAR system is also synchronized for cohesive data capture. Manual calibration is performed between recordings to maintain system accuracy. Data collection covers various natural lighting conditions, as presented in FIG. 16. The dataset comprises a total of 60,000 unlabeled frames and 36,000 manually annotated frames tailored for object detection across seven categories: Bike, Passenger-Car, Person, RoadObstruction, SemiTruck-Cab, SemiTruck-Trailer, Vehicle. To ensure accurate annotations, the dataset leverages both camera and LiDAR data in a complementary manner.

Dynamic Object Evaluation with FMCW Technology

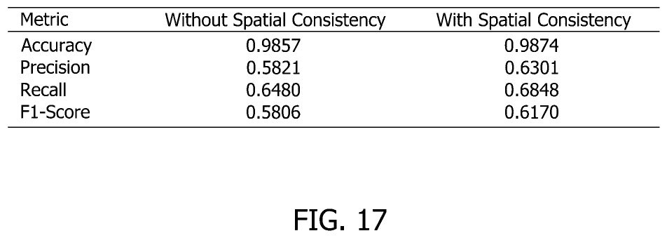

Frequency-Modulated Continuous-Wave (FMCW) LiDAR systems determine the velocity of a target by measuring the phase shift between the transmitted and received laser signals. The transmitted signal is a continuous wave with a linearly increasing frequency, known as a chirp. Upon reflection from a moving object, the received signal experiences a time delay t and a Doppler-induced phase shift Ao from which a radial velocity can be computed as follows:

$${s}_{r x} ( t ) = cos ( 2 π ( {f}_{0} ( t - τ ) ( \frac{{κ ( t - τ )}^{2}}{2} ) + Δ ϕ ) , v = \frac{Δ ϕ λ}{4 π}$$

where λ is the wavelength of the laser signal. Because the capability of the LiDAR of measuring radial velocity is not available for every dataset, it is deliberately not relied on in the method, as generalization is a key feature of the processing. However, this measurement can be used to evaluate the moving object segmentation as a binary classification of a point nature of being moving or nonmoving. To generate a ground truth, velocity measurements are segregated into positive and negative components to account for motion in different directions. For each subset of velocities, the mean (μ⁺), (μ⁻) and standard deviation (σ⁺), (σ⁻) are computed. A point is classified as moving if its velocity exceeds a dynamically determined threshold, specifically defined as μ⁺+2.0σ⁺ for positive velocities and |μ⁻|+2.0σ⁻ for negative velocities. This statistical approach ensures that only points exhibiting significant motion, relative to the overall velocity distribution, are considered moving, thereby reducing the influence of random noise and minor fluctuations. To further improve the robustness of the labeling process and mitigate the impact of isolated outliers, a neighborhood-based filtering mechanism is employed. For each point initially labeled as moving, the spatial vicinity is examined to verify the consistency of its motion classification. Utilizing spatial indexing structures such as a KD-tree, a moving point retains its label only if it is surrounded by a minimum number of other moving points within this neighborhood. If a moving point lacks sufficient neighboring moving points, it is disregarded as an outlier. This spatial consistency check ensures that motion labels are not only statistically significant but also supported by the local spatial context, as mostly in further regions the measurements noise affects speed computation. An evaluation is carried out without applying the spatial consistency check and applying it enforcing a constraint of 5 moving neighbors. Specifically select for this evaluation sequences in which no object moves perpendicularly to ego vehicle resulting in 1000 samples, as the Doppler shift can only be measured along each ray. In practice, as the LiDARs cover a 360° coverage, sensors scan all direction around the vehicle and as objects have a none zero extend, failure in the ground-truth measurements can only be induced in sequences where vehicles drive on a circular trajectory around the ego vehicle. Final results are summarized in table shown in FIG. 17.

### Implementation Details

The implementation of ƒₘₒₛ offers flexibility in adjusting the confidence threshold for detecting dynamic entities. The approach utilizes a confidence-based thresholding mechanism that allows the system to dynamically adjust its sensitivity to moving objects based on environmental conditions and sensor noise levels. This adaptability ensures that only reliably detected moving objects are segmented, thereby minimizing false positives and allowing the mapping module to focus more on static features of the environment.

For image semantic segmentation, the function ƒ_{seg} employs a multi-stage process that integrates a class-independent segmentation model, foundational image captioning techniques, and segmentation masks from a domain-aware model. The pipeline begins with preprocessing, where the original image is downscaled from 4K to HD resolution using for efficient processing. This step provides accurate object masks. Next, class-aware segmentation is performed using models trained on COCO, ADE20K, and Cityscapes datasets, yielding pixel-level class IDs that serve as priors for object classification. Each mask generated by is iteratively refined. For each object mask, pixel-level class IDs from the segmentation results are analyzed and consolidated to refine predictions. Further refinement is achieved by cropping and classifying individual objects. Image patches around each object are cropped at three scales—original resolution, 1.5×, and 0.5×—to ensure detailed analysis, especially for small objects. Open-vocabulary classification is performed on these patches using foundational models. The labeling module extracts associated classes by identifying nouns from descriptive captions and provides the top-k keywords. This step further enriches the semantic class proposals. Additionally, the labeling module performs boundary-aware classification on large objects, ensuring consistent segmentation along object boundaries. To address cases of multiple class proposals, the pipeline resolves inconsistencies by assigning the most frequent class ID based on pixel occurrence. The final resolved class IDs, along with their associated proposals, are incorporated into the annotation data.

Mapping Module (ƒₘₐₚ). The mapping component of the framework is implemented using an algorithm which provides a tightly-coupled LiDAR-Inertial Odometry and Mapping solution. This module can be modified to operate on the specific sensor setup employed and is deployed without GNSS measurements. Parameters are chosen in such a way that the algorithm prioritizes mapping accuracy over real-time processing in order to enhance precision and obtain detailed mapping. Because the algorithm is usually deployed on rotating LiDARs, it requires the channel information, which is not available in the case of solid state AEVA measurement. To simulate the behavior of a rotating LiDAR using a solid-state LiDAR, it is possible to employ a method that assigns each point in the point cloud to discrete virtual channels based on their elevation angles, thereby emulating the multi-beam scanning pattern of a mechanically rotating sensor without physically rotating the points. Let the vertical field of view of the LiDAR be denoted by O, which is discretized into N virtual channels with elevation angles θᵢ for i=1, 2, . . . , N. These angles are uniformly spaced within the range:

$${θ}_{i} = - \frac{θ}{2} + ( i - \frac{1}{2} ) \frac{θ}{N} , i = 1 , 2 , … , N$$

For each point with Cartesian coordinates (x, y, z) in the point cloud, compute its elevation angle φ relative to the horizontal plane as

$$ϕ = arctan ( \frac{z}{\sqrt{{x}^{2} + {y}^{2}}} )$$

The point is then assigned to the channel j that minimizes the absolute difference between its elevation angle and the predefined channel angles

$$j = \begin{matrix}arg min \\ k\end{matrix} \vert {θ}_{k} - ϕ \vert$$

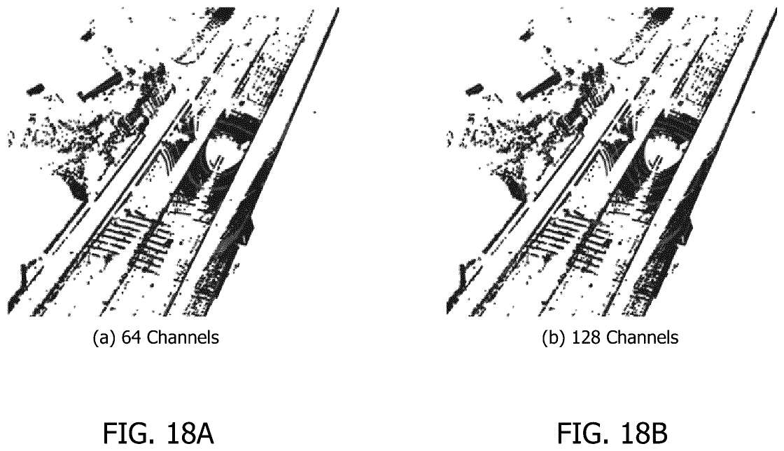

Simulating 128 horizontal scans permits not assigning too many points to the same channel, which would result in a worse feature matching from the mapping module: in FIGS. 18A and 18B, this is shown by comparison with a 64 layer simulation, where channels are thickened and far from each other, hindering the mapping process.

### Long Range Dataset

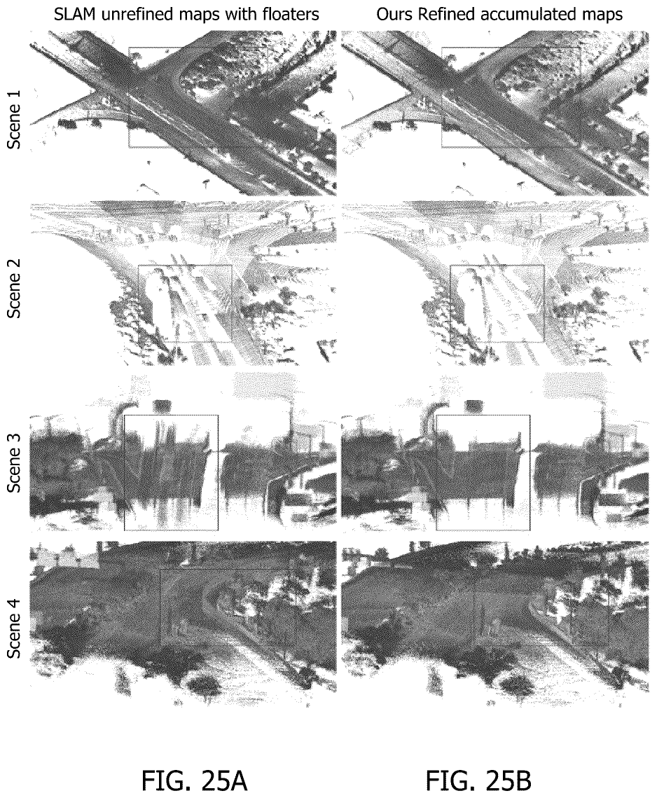

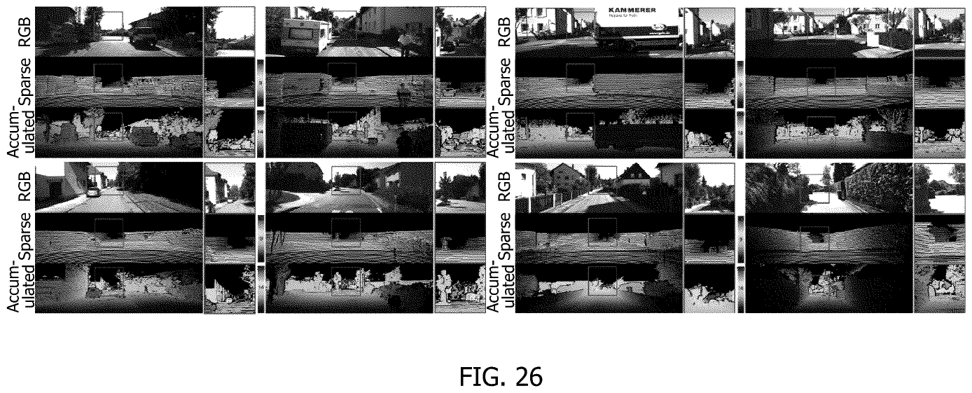

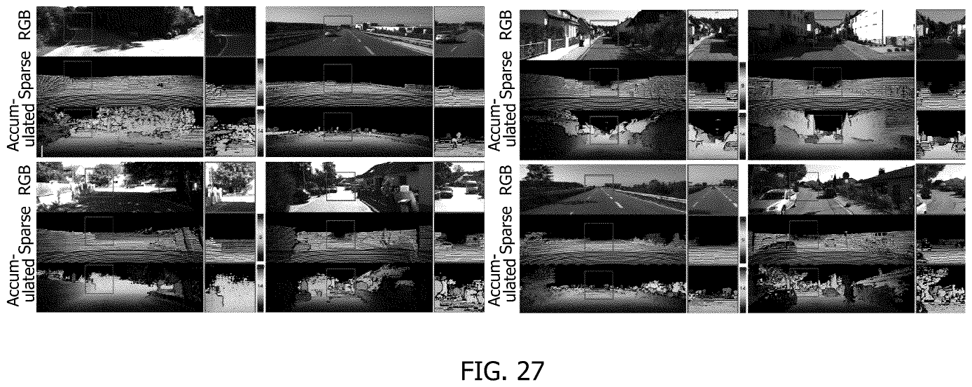

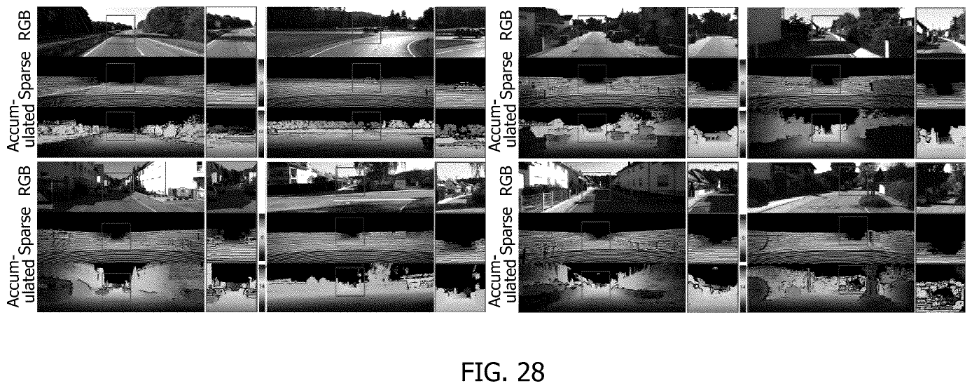

Following the procedure developed for the short-range dataset, generate 400 ground truth samples for training extracted from diverse highway scenes. For a fair comparison, fine-tune both pre-trained models on the sparse point cloud (e.g. LiDAR) recordings, as the sensor which may be used herein can capture points at longer ranges compared to the Velodyne HDL-64E deployed in the Karlsruhe Institute of Technology and Toyota Technological Institute dataset (KITTI), with the same frames and number of iterations used for fine-tuning on the accumulated ground-truth. The results are reported in FIG. 13, where observed is an improvement of 58.67%, 70.17% and 33.21% in MAE and 47.55%, 61.26%, 35.66% in RMSE for 0-80 m, 80-150 m, 150-250 m ranges respectively. Moreover, achieved are improvements of 59.59%, 48.41% and 34.57% in MAE and 59.98%, 51.24% and 45.93% in RMSE compared to the reference model (A†). For IGEV-Stereo, train on the same 400 stereo pairs until convergence and observe an improvement of 53.81%, 52.75% and 7.22% in MAE and 53.24%, 50.73% and 10.35% in RMSE for 0-80 m, 80-150 m, 150-250 m ranges respectively. Moreover, achieved are improvements of 78.69%, 71.15%, and 21.63% in MAE and 71.37%, 63.99%, and 19.06% in RMSE compared to the reference model (Δ†). On highway scenarios, reference SLAM system often encounter numerous dynamic objects that leave residual traces, or “floaters,” in the environment. These floaters degrade the accuracy of depth predictions and proves that this refinement method significantly enhances performance by effectively reducing these inaccuracies. FIGS. 25A and 25B illustrate the effectivity of removing floating artifacts in a pipeline from moving objects for four scenes (rows). Pseudo-label generation computing device 300 is able to remove consistently floaters (on the right, shown in FIG. 25B) with respect to the normal SLAM (on the left in FIG. 25A), in which points belonging to moving objects are retained in the map and appear smeared along their trajectories.

### Kalman-Filter Based Tracking

Operating recursively on streams of noisy input data to produce statistically optimal estimates of the underlying system state, the Kalman filter provides an efficient method to estimate the state of a process in a way that minimizes the mean squared error. Model the system based on a constant velocity model, assuming object's velocity remains the same between consecutive time steps, which is a reasonable approximation over short intervals in many real-world scenarios: specifically LiDAR-based system often running at 10 Hz, resulting in a recording every 100 milliseconds. Each object state is represented by a state vector x that includes its position, size, orientation, and velocities.

$$x = [ x y z l w h θ \dot{x} \dot{y} \dot{z} \dot{θ} ]$$

Initialize a high state covariance matrix for velocities, as the module does not exploit velocity measurements. Upon receiving new detections, the tracker module tries to match them to existing trackers using the Hungarian algorithm based on the 3D Intersection over Union (IoU). If a match is possible, the module updates trackers with assigned detections, otherwise new trackers for unmatched detections are created. Specifically in LiDAR and other point cloud data types, objects may be occluded for few timestamps or the pseudo bounding box may be missing, unmatched trackers are not deleted and the prediction step is done seamlessly. In this way, each timestamp the model tries to recover the lost track even if the Kalman Filter was not updated. Since evaluation algorithms for bounding box detections usually require the knowledge of a confidence score, exploit the uncertainty in the position estimates from the Kalman filter. A lower covariance indicates higher confidence. The score s for each object is then computed as

$$s = \frac{1}{\sqrt{det ( {P}_{p o s} ) + ϵ}}$$

where Pₚₒₛ is the covariance submatrix for position (x, y, z), and e is a small constant to prevent division by zero.

### Quadratic Optimization

Details on solving the B-spline based problem of refining yaw and position using quadratic optimization are described herein. To express the problem as a quadratic optimization problem, construct the matrices Q and b based on the contributions of each time point tⱼ. Specifically:

$$Q = {\sum }_{j} {Q}_{j} , b = {\sum }_{j} {b}_{j} ,$$

where Qⱼ and bⱼ are derived from the linear system formulation for each measurement. This leads to the following linear system representation of the yaw optimization problem:

$$Q \cdot w = b ,$$

where w contains the weights of the basis functions and Q and b are the system matrices that aggregate the contributions from all the measurements.

### Weight Vector

The weight vector w is the concatenation of w_{cos} and wₛᵢₙ, where

$${w}_{cos} = ( {y}_{0} , {\dot{y}}_{0} , {\ddot{y}}_{Δ {t}_{1}} , {\ddot{y}}_{Δ {t}_{1} + Δ {t}_{2}} , … )$$

$${w}_{sin} = ( {x}_{0} , {\dot{x}}_{0} , {\ddot{x}}_{Δ {t}_{1}} , {\ddot{x}}_{Δ {t}_{1} + Δ {t}_{2}} , … )$$

The weight vectors wₛᵢₙ and w_{cos} represent the parameters for the sine and cosine components of the yaw, respectively, at each time step. These parameters include the initial component values, the rate of change, and the second-order rate of change for each time step.

### Adding Regularization

To ensure a smooth and stable solution, add regularization terms to the cost function to smooth the yaw estimate. Apply a regularization based on the second derivative of the basis function. This can be expressed as

$${e}_{reg , 0} = \frac{1}{2} {\sum }_{k} {w}_{k}^{2}$$

$${e}_{reg , 1} = \frac{1}{2} {\sum }_{k} {( {w}_{k + 1} - {w}_{k} )}^{2}$$

The total regularized cost function becomes:

$${e}_{total} = {e}_{yaw \_ total} + α {e}_{reg , 0} + β {e}_{reg , 1} ,$$

where α=0.01 and β=0.02, were determined empirically to control the influence of the regularization terms on the overall optimization.

### Solving the Linear System

The regularized system can be represented as

$$( Q + {Q}_{r e g} ) \cdot w = b ,$$

where Q_{reg} includes the regularization terms. Solving this system for w yields the optimal parameters, resulting in a smooth yaw estimate.

### Optimization of Trajectories

To optimize object trajectories, apply a similar approach. Instead of estimating the sine and cosine components of the yaw, the method can directly estimate the x and y positions.

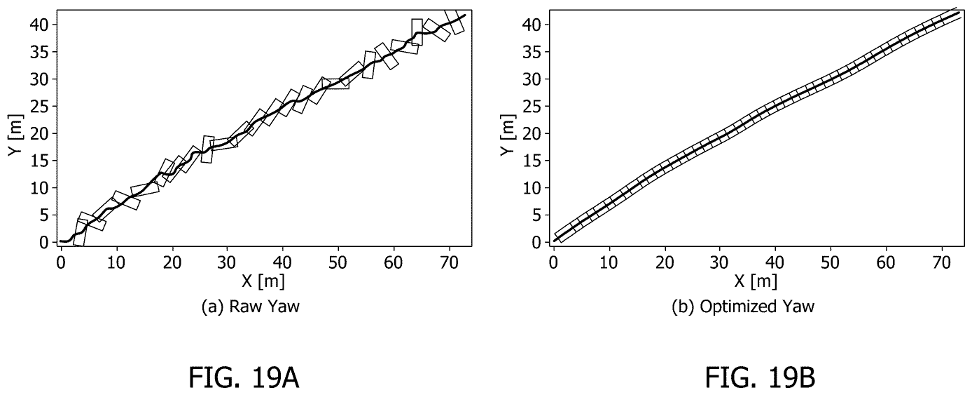

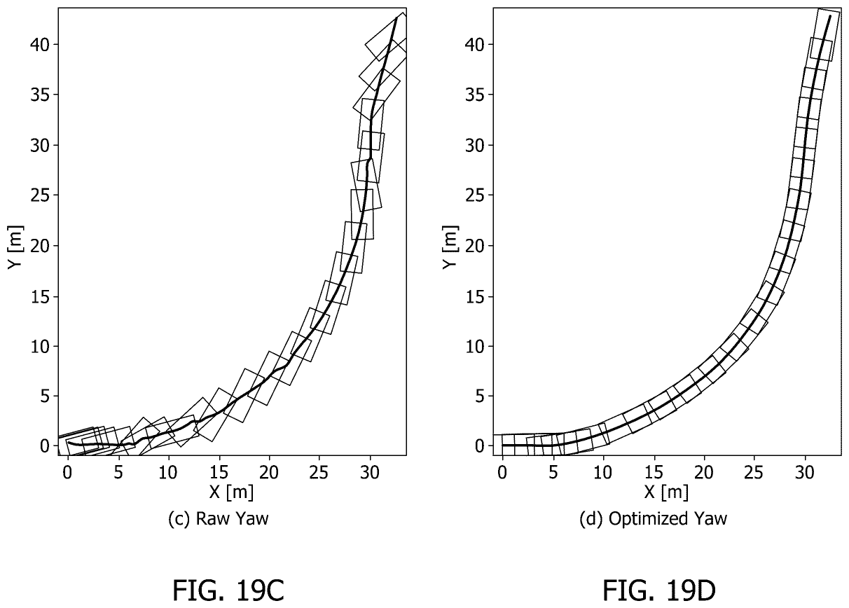

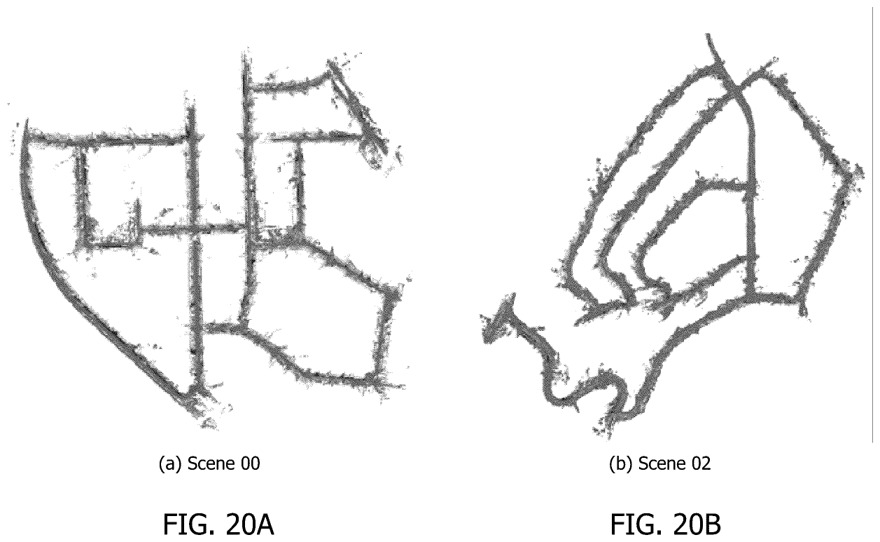

The position error function is defined as:

$${e}_{p osition} = \frac{1}{2} {\sum }_{j} ( {( {f}_{x} ( {t}_{j} ) - {x}_{j} )}^{2} + {( {f}_{y} ( {t}_{j} ) - {y}_{j} )}^{2} ) ,$$

where xⱼ and yⱼ represent the measured positions at time tⱼ. FIGS. 19A-19D present a comparison between two non-optimized and optimized results. FIGS. 20A and 20B show a Visualization of labeled map points from scenes 00 and 02 in the Semantic KITTI dataset, after applying semantic label propagation.

### Additional Evaluation and Details on Semantic Pseudo Labeling

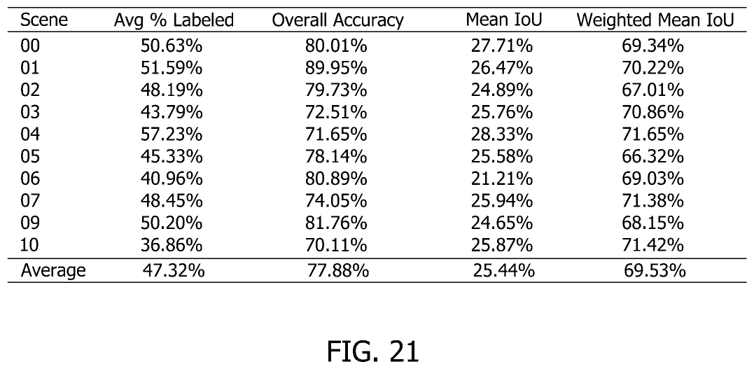

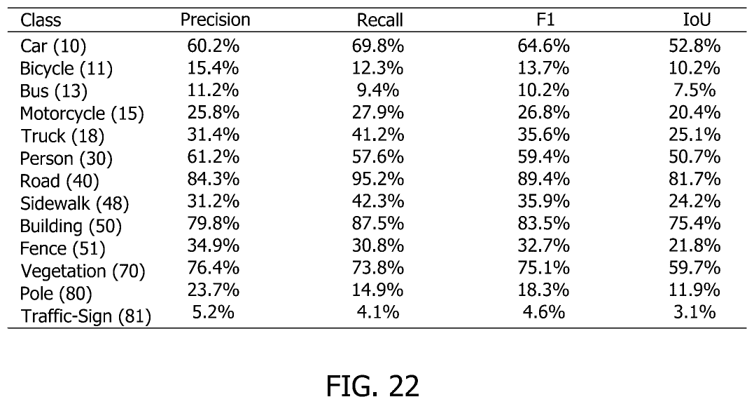

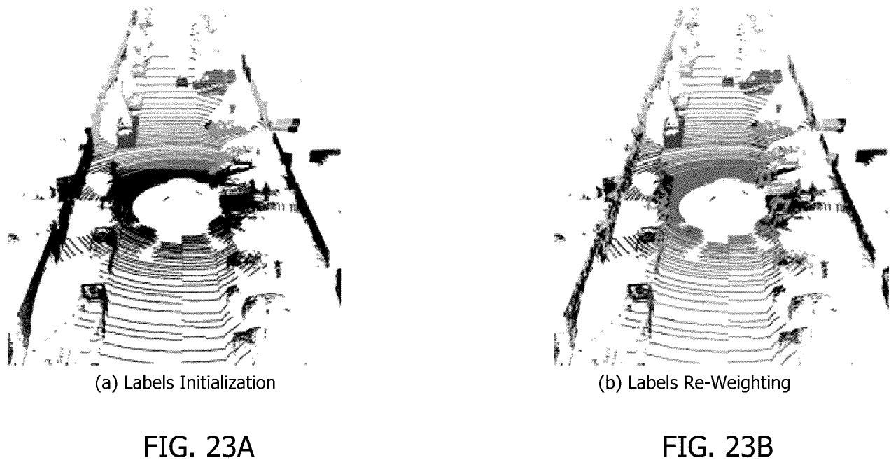

In this section, further details are provided on how nearly complete 360-degree semantic segmentation for each point cloud scan is achieved. FIGS. 23A and 23B illustrate an example using the Semantic Kitti dataset, presenting results in a before-and-after fashion. Initially, assign semantic labels to the Point cloud data using only the front left camera. Because the two stereo images overlap by approximately 90%, incorporating the right camera offers significant benefits primarily during the initial few time steps. To generate 360-degree pseudo labels, align each point cloud scan to the accumulated label map using the pose estimate T′ and assign labels to each point by comparing it to surrounding map points within a spherical neighborhood of 50 centimeters. Due to the limitation on label propagation, some regions in the map- and consequently some points in the Point cloud scans—remain unlabeled, as visible in FIGS. 4a and 4b. To further quantitatively assess the semantic pseudo labels produced by pseudo-label generation computing device 300, FIG. 21 reports the average percentage of point cloud points that receive a semantic label through the process. Additionally, the same table evaluates the quality of produced pseudo labels against the ground truth by calculating the overall accuracy, mean Intersection over Union (IoU), and a weighted mean IoU that accounts for the number of points per label in each scene. Furthermore, FIG. 22 provides an overview of the performance of pseudo labels in identifying each mapped class by presenting Precision, Recall, F1 score, and IoU across all training sequences.

An example technical effect of the methods, systems, and apparatus described herein includes at least one of: (a) reducing time and costs in producing labeled data for developing autonomous computing systems, (b) increasing the accuracy of the labeled maps, by propagating labels based on frequencies of semantic labels of points in the neighborhood, (c) providing additional labels of bounding boxes for moving objects, (d) providing depth maps of increased accuracy by removing occluded points, (e) increasing the speed and computational efficiency in the process of detecting and removing occluded points by using spherical coordinates during the removal process, and (f) reducing the likelihood of distant points being erroneously removed due to relatively low SNR of distant point by adjusting thresholds based ranges of points from the sensor origin.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A pseudo-label generation computing device for pseudo-labeling three-dimensional (3D) point clouds for developing an autonomous vehicle, the pseudo-label generation computing device comprising at least one processor in communication with at least one memory device, the at least one processor programmed to:
receive first sensor data of an environment in which an autonomous vehicle could travel, the first sensor data acquired by at least one first sensor of a first modality and being in 3D point clouds;
receive second sensor data of the environment, the second sensor data acquired by at least one second sensor of a second modality and including semantic information;
generate second semantic maps of the second modality based on the second sensor data, the second semantic maps including semantic labels of objects in the environment;
generate first semantic maps of the first modality based on the second semantic maps;
generate a world map of the first sensor data by:
removing moving objects from the first sensor data to derive static first sensor data; and
accumulating the static first sensor data into the world map;
generate a labeled map of the first sensor data by combining the first semantic maps with the world map, the labeled map including the semantic labels; and
output the labeled map.

2. The pseudo-label generation computing device of claim 1, wherein the at least one processor is further programmed to:
generate the labeled map by:
propagating the semantic labels in the first semantic maps to unlabeled points in the world map.

3. The pseudo-label generation computing device of claim 2, wherein the at least one processor is further programmed to:
propagate the semantic labels by assigning a semantic label for a point in the point clouds based on frequencies of semantic labels of points in a neighborhood of the point.

4. The pseudo-label generation computing device of claim 1, wherein the at least one processor is further programmed to:
refine the labeled map by:
comparing the first sensor data in temporal frames with the labeled map; and
removing false static points in the labeled map based on a frequency of a point in the first sensor data appearing across the temporal frames.

5. The pseudo-label generation computing device of claim 4, wherein the at least one processor is further programmed to:
adjust a probability of the point being static based on a range, wherein the range is a distance of the point from a sensor origin.

6. The pseudo-label generation computing device of claim 4, wherein the at least one processor is further programmed to:
adjust a probability of the point being static based on a label influence factor associated with a confidence level of a label of the point.

7. The pseudo-label generation computing device of claim 1, wherein the at least one processor is further programmed to:
identify the moving objects in the first sensor data by:
comparing the first sensor data with the labeled map; and
identifying a point as moving based on comparison using an adjustable threshold as a function of at least one of i) a distance of the point from its nearest neighbor in the labeled map or ii) a range at the point in the labeled map, wherein a range at the point is a distance of the point from a sensor origin; and
generate bounding boxes based on identified moving objects.

8. The pseudo-label generation computing device of claim 1, wherein the at least one processor is further programmed to:
generate a depth map based on the labeled map by:
removing occluded points from the labeled map using a spherical coordinates system.

9. The pseudo-label generation computing device of claim 8, wherein the at least one processor is further programmed to:
remove the occluded points using an adjustable threshold as a function of a range at a point in the labeled map, wherein the range at the point is a distance of the point from a sensor origin.

10. At least one non-transitory computer-readable storage medium for pseudo-labeling three-dimensional (3D) point clouds for developing an autonomous vehicle, the at least one non-transitory computer-readable storage medium comprising a plurality of instructions stored thereon that, in response to being executed, cause a system to:
receive first sensor data of an environment in which an autonomous vehicle could travel, the first sensor data acquired by at least one first sensor of a first modality and being in 3D point clouds;
receive second sensor data of the environment the second sensor data acquired by at least one second sensor of a second modality and including semantic information;
generate second semantic maps of the second modality based on the second sensor data, the second semantic maps including semantic labels of objects in the environment;
generate first semantic maps of the first modality based on the second semantic maps;
generate a world map of the first sensor data by:
removing moving objects from the first sensor data to derive static first sensor data; and
accumulating the static first sensor data into the world map;
generate a labeled map of the first sensor data by combining the first semantic maps with the world map, the labeled map including the semantic labels; and
output the labeled map.

11. The least one non-transitory computer-readable storage medium of claim 10, wherein the plurality of instructions further cause the system to:
generate the labeled map by:
propagating the semantic labels in the first semantic maps to unlabeled points in the world map.

12. The least one non-transitory computer-readable storage medium of claim 11, wherein the plurality of instructions further cause the system to:
propagate the semantic labels by assigning a semantic label for a point in the point clouds based on frequencies of semantic labels of points in a neighborhood of the point.

13. The least one non-transitory computer-readable storage medium of claim 10, wherein the plurality of instructions further cause the system to:
refine the labeled map by:
comparing the first sensor data in temporal frames with the labeled map; and
removing false static points in the labeled map based on a frequency of a point in the first sensor data appearing across the temporal frames.

14. The least one non-transitory computer-readable storage medium of claim 13, wherein the plurality of instructions further cause the system to:
adjust a probability of the point being static based on a range, wherein the range is a distance of the point from a sensor origin.

15. The least one non-transitory computer-readable storage medium of claim 13, wherein the plurality of instructions further cause the system to:
adjust a probability of the point being static based on a label influence factor associated with a confidence level of a label of the point.

16. The least one non-transitory computer-readable storage medium of claim 13, wherein the plurality of instructions further cause the system to:
identify the moving objects in the first sensor data by:
comparing the first sensor data with the labeled map; and
identifying a point as moving based on comparison using an adjustable threshold as a function of at least one of i) a distance of the point from its nearest neighbor in the labeled map or ii) a range at the point in the labeled map, wherein a range at the point is a distance of the point from a sensor origin; and
generate bounding boxes based on identified moving objects.

17. The least one non-transitory computer-readable storage medium of claim 10, wherein the plurality of instructions further cause the system to:
generate a depth map based on the labeled map by:
removing occluded points from the labeled map using a spherical coordinates system.

18. The least one non-transitory computer-readable storage medium of claim 10, wherein the plurality of instructions further cause the system to:
generate first semantic maps of the first modality based on the second semantic maps by:
projecting the first sensor data onto the second sensor data to obtain projected sensor data;
generating projected semantic maps of the first modality based on the projected sensor data and the second semantic maps; and
generating the first semantic maps by projecting the projected semantic maps back to a format of the first sensor data.

19. A method for generating pseudo-labels for three-dimensional (3D) point clouds for developing an autonomous vehicle, the method comprising:
receiving first sensor data of an environment in which an autonomous vehicle could travel, the first sensor data acquired by at least one first sensor of a first modality and being in 3D point clouds;
receiving second sensor data of the environment, the second sensor data acquired by at least one second sensor of a second modality and including semantic information;
generating second semantic maps of the second modality based on the second sensor data, the second semantic maps including semantic labels of objects in the environment;
generating first semantic maps of the first modality based on the second semantic maps;
generating a world map of the first sensor data by:
removing moving objects from the first sensor data to derive static first sensor data; and
accumulating the static first sensor data into the world map;
generating a labeled map of the first sensor data by combining the first semantic maps with the world map, the labeled map including the semantic labels; and
outputting the labeled map.

20. The method of claim 19, the method further comprising:
generating the labeled map by:
propagating the semantic labels in the first semantic maps to unlabeled points in the world map.
